(19) United States
(12) Patent Application Publication
(10) Pub. No.: US 2026/0121524 A1
(43) Pub. Date: Apr. 30, 2026

(54) DIRECT CURRENT (DC)-DC CONVERSION CIRCUITS AND POWER CONVERSION CIRCUITS INCLUDING THE SAME

(71) Applicant: Lian Zheng Electronics (Shenzhen) Co., Ltd., Shenzhen (CN)

(72) Inventors: Yusong Ding, Shenzhen (CN); Zhongyong Xu, Shenzhen (CN)

(21) Appl. No.: 19/370,878

(22) Filed: Oct. 28, 2025

(30) Foreign Application Priority Data
Oct. 29, 2024 (CN) 202411527011.5

(51) Int. Cl. H02M 1/44; H02J 7/00; H02J 9/06; H02M 3/158

(52) U.S. Cl. CPC H02M 1/44; H02J 7/865; H02J 9/06; H02M 3/1582; H02J 2207/20

(57) ABSTRACT

A DC-DC conversion circuit including a positive and a negative buses, a DC power supply, and a DC conversion unit, is provided. A negative electrode of the power supply is connected to a neutral line between the positive and the negative buses. The DC conversion unit includes a first, a second, a third, and a fourth semiconductor switches, and a first inductor. Terminals of the first semiconductor switch are connected to the positive bus and a first terminal of the first inductor, terminals of the fourth semiconductor switch are connected to a second terminal of the first inductor and a positive electrode of the power supply, terminals of the second semiconductor switch are connected to the first terminal of the first inductor and the neutral line, and terminals of the third semiconductor switch are connected to the second terminal of the first inductor and the negative bus.

### CROSS-REFERENCE TO RELATED APPLICATION

The present application claims the benefit of and priority to Chinese Invention patent application No. 202411527011.5, titled “DC-DC CONVERSION CIRCUIT AND POWER CONVERSION CIRCUIT INCLUDING SAME,” filed Oct. 29, 2024, the content of which is hereby incorporated herein by reference in its entirety.

### FIELD

The present inventive concept relayed generally to the field of power electronics, and in particular, to a DC-DC conversion circuits and a power conversion circuits including the DC-DC conversion circuits.

### BACKGROUND

An uninterruptible power supply (UPS) is configured to instantaneously switch from a mains supply to a direct current power supply to provide continuous power to a load when the mains supply is abnormal, so as to protect the load from damage due to interruption of the mains power. Therefore, the UPS is widely used in industrial, commercial, and consumer fields. A DC-DC converter (that is, a DC-DC conversion circuit) is an electric installation widely used in the uninterruptible power supply. An input terminal of the DC-DC converter is connected to a rechargeable battery, and an output terminal of the DC-DC converter is connected to a positive direct current bus and a negative direct current bus in the uninterruptible power supply. When the mains supply fails, the DC-DC converter boosts a direct current in the rechargeable battery and outputs the direct current to the positive direct current bus and the negative direct current bus. Due to a circuit structure and a control manner of an existing DC-DC converter, it is prone to problems such as poor electromagnetic compatibility (EMC) and low charging or power supply efficiency.

### SUMMARY

Some embodiment of the present inventive concept provide DC-DC conversion circuits and a power conversion circuits including the same, which may effectively resolve the problems of poor EMC and low charging or power supply efficiency.

In some embodiments of the present inventive concept, a DC-DC conversion circuit is provided, including: a positive direct current bus and a negative direct current bus, wherein a positive direct current bus capacitor and a negative direct current bus capacitor that are connected in series with each other are electrically connected between the positive direct current bus and the negative direct current bus, and a node between the positive direct current bus capacitor and the negative direct current bus capacitor is connected to a neutral line; a rechargeable direct current power supply, wherein a negative electrode of the direct current power supply is connected to the neutral line; and a direct current conversion unit, including a first semiconductor switching device, a second semiconductor switching device, a third semiconductor switching device, a fourth semiconductor switching device, and a first inductor, wherein two terminals of the first semiconductor switching device are respectively connected to the positive direct current bus and a first terminal of the first inductor, two terminals of the fourth semiconductor switching device are respectively connected to a second terminal of the first inductor and a positive electrode of the direct current power supply, two terminals of the second semiconductor switching device are respectively connected to the first terminal of the first inductor and the neutral line, and two terminals of the third semiconductor switching device are respectively connected to the second terminal of the first inductor and the negative direct current bus; and the positive direct current bus and the negative direct current bus charge the direct current power supply through the direct current conversion unit, and/or the direct current power supply supplies power to the positive direct current bus and the negative direct current bus through the direct current conversion unit.

In further embodiments, the first semiconductor switching device and the third semiconductor switching device are controllable semiconductor switching devices with anti-parallel diodes, and the second semiconductor switching device and the fourth semiconductor switching device are diodes; and the first semiconductor switching device is configured to be alternately switched on, the third semiconductor switching device is configured to be switched off, and the positive direct current bus charges the direct current power supply; or the first semiconductor switching device is configured to be switched off, the third semiconductor switching device is configured to be alternately switched on, and the negative direct current bus charges the direct current power supply.

In still further embodiments, the first semiconductor switching device and the third semiconductor switching device are diodes, and the second semiconductor switching device and the fourth semiconductor switching device are controllable semiconductor switching devices with anti-parallel diodes; and the second semiconductor switching device is configured to be alternately switched on, the fourth semiconductor switching device is configured to be switched on, and the direct current power supply supplies power to the positive direct current bus; or the second semiconductor switching device is configured to be switched on, the fourth semiconductor switching device is configured to be alternately switched on, and the direct current power supply supplies power to the negative direct current bus.

In some embodiments, the first semiconductor switching device, the second semiconductor switching device, the third semiconductor switching device, and the fourth semiconductor switching device are all controllable semiconductor switching devices with anti-parallel diodes; and the first semiconductor switching device is configured to be alternately switched on, the second semiconductor switching device, the third semiconductor switching device, and the fourth semiconductor switching device are configured to be switched off, and the positive direct current bus charges the direct current power supply; or the third semiconductor switching device is configured to be alternately switched on, the first semiconductor switching device, the second semiconductor switching device, and the fourth semiconductor switching device are configured to be switched off, and the negative direct current bus charges the direct current power supply; or the fourth semiconductor switching device is configured to be switched on, the second semiconductor switching device is configured to be alternately switched on, the first semiconductor switching device and the third semiconductor switching device are configured to be switched off, and the direct current power supply supplies power to the positive direct current bus; or the fourth semiconductor switching device is configured to be alternately switched on, the second semiconductor switching device is configured to be switched on, the first semiconductor switching device and the third semiconductor switching device are configured to be switched off, and the direct current power supply supplies power to the negative direct current bus.

Further embodiments of the present inventive concept provide DC-DC conversion circuits including: a positive direct current bus and a negative direct current bus, wherein a positive direct current bus capacitor and a negative direct current bus capacitor that are connected in series with each other are electrically connected between the positive direct current bus and the negative direct current bus, and a node between the positive direct current bus capacitor and the negative direct current bus capacitor is connected to a neutral line; a rechargeable direct current power supply, wherein a positive electrode of the direct current power supply is connected to the neutral line; and a direct current conversion unit, including a first semiconductor switching device, a second semiconductor switching device, a third semiconductor switching device, a fourth semiconductor switching device, and a first inductor, wherein two terminals of the first semiconductor switching device are respectively connected to the negative direct current bus and a first terminal of the first inductor, two terminals of the fourth semiconductor switching device are respectively connected to a second terminal of the first inductor and a negative electrode of the direct current power supply, two terminals of the second semiconductor switching device are respectively connected to the first terminal of the first inductor and the neutral line, and two terminals of the third semiconductor switching device are respectively connected to the second terminal of the first inductor and the positive direct current bus; and the positive direct current bus and the negative direct current bus charge the direct current power supply through the direct current conversion unit, and/or the direct current power supply supplies power to the positive direct current bus and the negative direct current bus through the direct current conversion unit.

In still further embodiments, the first semiconductor switching device and the third semiconductor switching device are controllable semiconductor switching devices with anti-parallel diodes, and the second semiconductor switching device and the fourth semiconductor switching device are diodes; and the first semiconductor switching device is configured to be alternately switched on, the third semiconductor switching device is configured to be switched off, and the negative direct current bus charges the direct current power supply; or the first semiconductor switching device is configured to be switched off, the third semiconductor switching device is configured to be alternately switched on, and the positive direct current bus charges the direct current power supply.

In some embodiments, the first semiconductor switching device and the third semiconductor switching device are diodes, and the second semiconductor switching device and the fourth semiconductor switching device are controllable semiconductor switching devices with anti-parallel diodes; and the second semiconductor switching device is configured to be alternately switched on, the fourth semiconductor switching device is configured to be switched on, and the direct current power supply supplies power to the negative direct current bus; or the second semiconductor switching device is configured to be switched on, the fourth semiconductor switching device is configured to be alternately switched on, and the direct current power supply supplies power to the positive direct current bus.

In further embodiments, the first semiconductor switching device, the second semiconductor switching device, the third semiconductor switching device, and the fourth semiconductor switching device are all controllable semiconductor switching devices with anti-parallel diodes; and the first semiconductor switching device is configured to be alternately switched on, the second semiconductor switching device, the third semiconductor switching device, and the fourth semiconductor switching device are configured to be switched off, and the negative direct current bus charges the direct current power supply; or the third semiconductor switching device is configured to be alternately switched on, the first semiconductor switching device, the second semiconductor switching device, and the fourth semiconductor switching device are configured to be switched off, and the positive direct current bus charges the direct current power supply; or the fourth semiconductor switching device is configured to be switched on, the second semiconductor switching device is configured to be alternately switched on, the first semiconductor switching device and the third semiconductor switching device are configured to be switched off, and the direct current power supply supplies power to the negative direct current bus; or the fourth semiconductor switching device is configured to be alternately switched on, the second semiconductor switching device is configured to be switched on, the first semiconductor switching device and the third semiconductor switching device are configured to be switched off, and the direct current power supply supplies power to the positive direct current bus.

Still further embodiments of the present inventive concept provide power conversion circuits including a first switch, a rectifier unit, and the DC-DC conversion circuit according to any one of the first aspect or the second aspect. A first terminal of the first switch is connected to a mains supply, a second terminal of the first switch is connected to an input terminal of the rectifier unit, and output terminals of the rectifier unit are connected to the positive direct current bus, the negative direct current bus, and the neutral line.

In some embodiments, the power conversion circuit further includes a second switch, a first terminal of the second switch is connected to the second terminal of the first switch, and a second terminal of the second switch is connected to the second terminal of the first inductor.

In further embodiments, the power conversion circuit further includes a third switch, a first terminal of the third switch is connected to the second terminal of the first inductor, and a second terminal of the third switch is connected to a common connection point between the third semiconductor switching device and the fourth semiconductor switching device; or the first terminal of the third switch is connected to the first terminal of the first inductor, and the second terminal of the third switch is connected to a common connection point between the first semiconductor switching device and the second semiconductor switching device.

Still further embodiments of the present inventive concept provide uninterruptible power supplies. The uninterruptible power supply includes the DC-DC conversion circuit according to any one of the first aspect or the second aspect, or the power conversion circuit according to any one of the third aspect.

In the DC-DC conversion circuit in embodiments of the present inventive concept, only a single-side bus in a dual direct current bus works, which is more suitable for a single-phase alternating current mains input UPS. In addition, a voltage difference between two terminals of the DC-DC conversion circuit is small, and efficiency is high. The battery negative electrode is directly connected to the neutral line. Therefore, the EMC characteristic of the circuit is good, reliability of circuit running can be improved, and the circuit can be further used in a battery-sharing parallel system of a single-battery UPS. In addition, the circuit has only one inductor, which can save costs and space.

### BRIEF DESCRIPTION OF DRAWINGS

FIG. 1 shows a schematic diagram of a first type of DC-DC conversion circuit connected between a direct current bus and a rechargeable battery in accordance with some embodiments of the present inventive concept.

FIG. 2 shows a schematic diagram of a second type of DC-DC conversion circuit connected between a direct current bus and a rechargeable battery in accordance with some embodiments of the present inventive concept.

FIG. 3 shows a schematic diagram of waveforms of a related component when the circuit shown in FIG. 2 works in accordance with some embodiments of the present inventive concept.

FIG. 4 shows a schematic diagram of a third type of DC-DC conversion circuit connected between a direct current bus and a battery in accordance with some embodiments of the present inventive concept.

FIG. 5 shows a schematic diagram of a fourth type of DC-DC conversion circuit connected between a direct current bus and a battery in accordance with some embodiments of the present inventive concept.

FIG. 6 shows a schematic topology of a DC-DC conversion circuit according to an embodiment of the present inventive concept in accordance with some embodiments of the present inventive concept.

FIG. 7A and FIG. 7B respectively show schematic diagrams of equivalent circuits corresponding to that a direct current bus stores energy to an inductor and charges a battery (FIG. 7A) and that the inductor charges the battery (FIG. 7B) when a positive direct current bus BUS+ of the circuit topology in the embodiment shown in FIG. 6 is used as an input in accordance with some embodiments of the present inventive concept.

FIG. 7C and FIG. 7D respectively show schematic diagrams of equivalent circuits corresponding to that a direct current bus stores energy to an inductor (FIG. 7C) and that the inductor charges a battery (FIG. 7D) when a negative direct current bus BUS− of the circuit topology in the embodiment shown in FIG. 6 is used as an input in accordance with some embodiments of the present inventive concept.

FIG. 8 shows a schematic topology of a DC-DC conversion circuit in accordance with some embodiments of the present inventive concept;

FIG. 9 shows a schematic topology of a DC-DC conversion circuit in accordance with some embodiments of the present inventive concept.

FIG. 10A and FIG. 10B respectively show schematic diagrams of equivalent circuits corresponding to that a positive direct current bus BUS+ stores energy to an inductor and charges a battery (FIG. 10A) and that the inductor charges the battery (FIG. 10B) when a direct current bus of the circuit topology in the embodiment shown in FIG. 9 charges the battery in accordance with some embodiments of the present inventive concept.

FIG. 10C and FIG. 10D respectively show schematic diagrams of equivalent circuits corresponding to that a negative direct current bus BUS− stores energy to an inductor (FIG. 10C) and that the inductor charges a battery (FIG. 10D) when a direct current bus of the circuit topology in the embodiment shown in FIG. 9 charges the battery in accordance with some embodiments of the present inventive concept.

FIG. 10E and FIG. 10F respectively show schematic diagrams of equivalent circuits corresponding to that a battery stores energy to an inductor (FIG. 10E) and that the inductor supplies power to a positive direct current bus BUS+ (FIG. 10F) when the battery of the circuit topology in the embodiment shown in FIG. 9 supplies power to a direct current bus in accordance with some embodiments of the present inventive concept.

FIG. 10G and FIG. 10H respectively show schematic diagrams of equivalent circuits corresponding to that a battery stores energy to an inductor (FIG. 10G) and that the inductor supplies power to a negative direct current bus BUS− (FIG. 10H) when the battery of the circuit topology in the embodiment shown in FIG. 9 supplies power to a direct current bus in accordance with some embodiments of the present inventive concept.

FIG. 11 shows a schematic topology of a DC-DC conversion circuit mirrored with that of FIG. 6 in accordance with some embodiments of the present inventive concept.

FIG. 12 shows a schematic topology of a DC-DC conversion circuit mirrored with that of FIG. 8 in accordance with some embodiments of the present inventive concept.

FIG. 13 shows a schematic topology of a DC-DC conversion circuit mirrored with that of FIG. 9 in accordance with some embodiments of the present inventive concept.

FIG. 14 shows a schematic topology of a power conversion circuit in accordance with some embodiments of the present inventive concept.

FIG. 15A shows a schematic diagram of an equivalent circuit corresponding to that the mains supply supplies power to a positive direct current bus and the positive direct current bus charges a battery in a positive half cycle of a mains supply mode of the circuit topology in the embodiment shown in FIG. 14 in accordance with some embodiments of the present inventive concept.

FIG. 15B shows a schematic diagram of an equivalent circuit corresponding to that the mains supply supplies power to a negative direct current bus and the negative direct current bus charges a battery in a negative half cycle of a mains supply mode of the circuit topology in the embodiment shown in FIG. 14 in accordance with some embodiments of the present inventive concept.

FIG. 16A shows a schematic diagram of an equivalent circuit corresponding that a battery supplies power to a positive direct current bus when a UPS in battery mode of the circuit topology in the embodiment shown in FIG. 14 works in a positive half cycle of the power frequency;

FIG. 16B shows a schematic diagram of an equivalent circuit corresponding that a battery supplies power to a negative direct current bus when a UPS in battery mode of the circuit topology in the embodiment shown in FIG. 14 works in a negative half cycle of the power frequency;

FIG. 17A shows a schematic topology of a power conversion circuit according to an embodiment of the present inventive concept;

FIG. 17B shows a schematic topology of a power conversion circuit in accordance with some embodiments of the present inventive concept.

FIG. 18A shows a schematic diagram of an equivalent circuit corresponding that a battery supplies power to a positive direct current bus when a UPS in battery mode of the circuit topology in the embodiment shown in FIG. 17A works in a positive half cycle of the power frequency in accordance with some embodiments of the present inventive concept.

FIG. 18B shows a schematic diagram of an equivalent circuit corresponding that a battery supplies power to a negative direct current bus when a UPS in battery mode of the circuit topology in the embodiment shown in FIG. 17A works in a negative half cycle of the power frequency in accordance with some embodiments of the present inventive concept.

FIG. 19 shows a schematic topology of a power conversion circuit including a first type of replacement rectifier unit in accordance with some embodiments of the present inventive concept.

FIG. 20 shows a schematic topology of a power conversion circuit including a second type of replacement rectifier unit in accordance with some embodiments of the present inventive concept.

FIG. 21 shows a schematic topology of a power conversion circuit including a third type of replacement rectifier unit in accordance with some embodiments of the present inventive concept.

### DETAILED DESCRIPTION

The following describes in detail specific embodiments of the present inventive concept with reference to the accompanying drawings. It should be noted that the embodiments herein are merely used as examples for description, and are not intended to limit the present inventive concept. In the following description, a large number of specific details are described to provide a thorough understanding of the present inventive concept. However, it is apparent to those of ordinary skill in the art that these specific details are not necessary to implement the present inventive concept. In other examples, well-known procedures, materials, or methods are not specifically described to avoid confusion with the present inventive concept. Words such as “first” and “second” that appear in the embodiments do not represent an order or a sequence of occurrence, but are merely used to distinguish between different branches or component names.

FIG. 1 shows a schematic diagram of a first type of DC-DC conversion circuit connected between direct current buses and a rechargeable battery. As shown in FIG. 1, a positive direct current bus capacitor C1 and a negative direct current bus capacitor C2 that are connected in series with each other are electrically connected between a positive direct current bus BUS+ and a negative direct current bus BUS−, and a neutral line N0 is disposed between the positive direct current bus capacitor C1 and the negative direct current bus capacitor C2. The DC-DC conversion circuit includes a switching transistor Q1, a diode D1, and an inductor L1. A first electrode of the switching transistor Q1 is connected to a first terminal of the inductor L1 and a cathode of the diode D1, a second electrode of the switching transistor Q1 and an anode of the diode D1 are respectively connected to the positive direct current bus BUS+ and the negative direct current bus BUS−, and the anode of the diode D1 and a second terminal of the inductor L1 are respectively connected to the negative electrode DC− of the battery and the positive electrode DC+ of the battery. A control apparatus (not shown in FIG. 1) provides a pulse width modulation signal to a control terminal of the switching transistor Q1 (that is, performs modulation control), to charge the battery by using electric energy on the positive direct current bus BUS+ and the negative direct current bus BUS−.

When the circuit shown in FIG. 1 is applied to a charger of a single-battery UPS, a PFC circuit (or a rectifier unit, not shown in FIG. 1) that is connected to the direct current buses when the circuit works provides electrical energy to the positive direct current bus BUS+ in a positive half cycle, and provides electrical energy to the negative direct current bus BUS− in a negative half cycle. However, the circuit shown in FIG. 1 simultaneously takes electrical energy from the positive direct current bus BUS+ and the negative direct current bus BUS− either in the positive half cycle or the negative half cycle, so that voltage ripple of the direct current bus capacitors is large. For example, in the positive half cycle, the positive direct current bus BUS+ can obtain electrical energy from the PFC circuit and provide the electrical energy to the circuit shown in FIG. 1. In this case, the PFC circuit does not supply power to the negative direct current bus BUS−. Therefore, it is necessary to take electrical energy from the negative direct current bus capacitor C2 and provide the electrical energy to a power conversion circuit. In this case, a direct current bus capacitor with a larger capacity is required, and the difficulty in controlling a voltage of the direct current bus capacitor is increased. In addition, in the circuit shown in FIG. 1, for a UPS with a power range of 5-11 kVA, a voltage of the direct current bus is generally about 700 V, a voltage of the battery is an output voltage of about 200 V of the power conversion circuit, and a buck voltage difference between an input terminal and an output terminal is large, resulting in a low charging efficiency of the circuit.

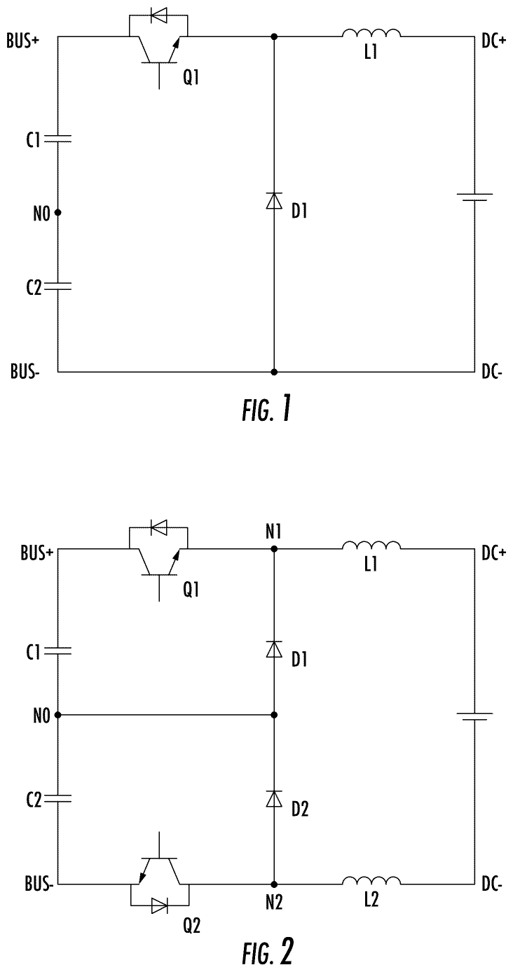

FIG. 2 shows a schematic diagram of a second type of DC-DC conversion circuit connected between direct current buses and a battery. As shown in FIG. 2, a positive direct current bus capacitor C1 and a negative direct current bus capacitor C2 that are connected in series with each other are electrically connected between a positive direct current bus BUS+ and a negative direct current bus BUS−, and a node between the positive direct current bus capacitor C1 and the negative direct current bus capacitor C2 is connected to a neutral line N0. The DC-DC conversion circuit includes a switching transistor Q1, a diode D1, an inductor L1, a switching transistor Q2, a diode D2, and an inductor L2. The switching transistor Q1 and the inductor L1 are sequentially connected in series between the positive direct current bus BUS+ and the positive electrode DC+ of a battery, a second electrode of the switching transistor Q1 is connected to the positive direct current bus BUS+, a first electrode of the switching transistor Q1 is connected to a first terminal of the inductor L1, and a second terminal of the inductor L1 is connected to the positive electrode DC+ of the battery. The switching transistor Q2 and the inductor L2 are sequentially connected in series between the negative direct current bus BUS− and the negative electrode DC− of the battery, a first electrode of the switching transistor Q2 is connected to the negative direct current bus BUS−, a second electrode of the switching transistor Q2 is connected to a first terminal of the inductor L2, and a second terminal of the inductor L2 is connected to the negative electrode DC− of the battery. The diode D1 and the diode D2 are connected in series between a first node N1 and a second node N2, a cathode of the diode D1 is connected to the first node N1, an anode of the diode D1 is connected to a cathode of the diode D2, an anode of the diode D2 is connected to the second node N2, the first node N1 is located between the switching transistor Q1 and the inductor L1, and the second node N2 is located between the switching transistor Q2 and the inductor L2. The anode of diode D1 and the cathode of diode D2 are separately connected to neutral line N0.

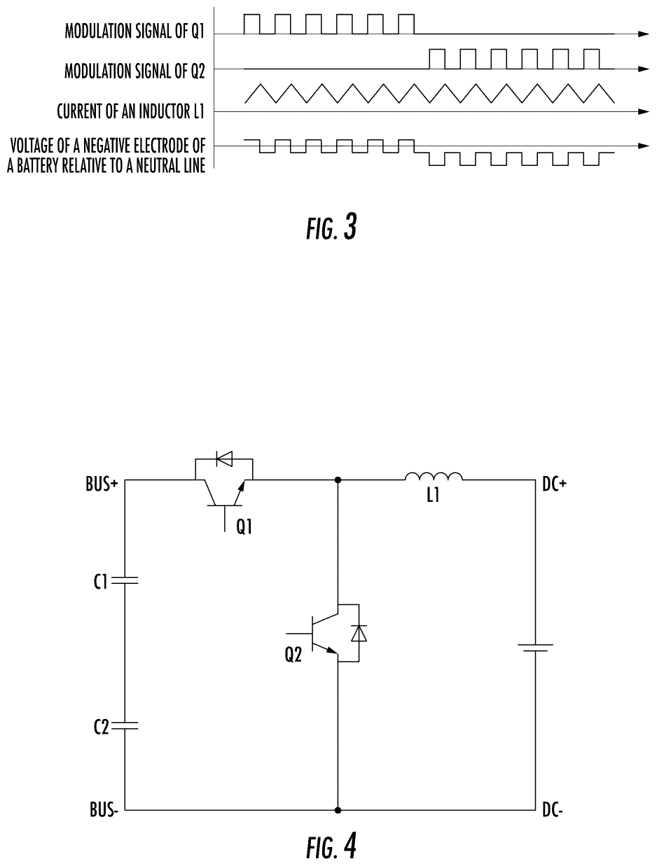

FIG. 3 shows a schematic diagram of waveforms of a related component when the circuit shown in FIG. 2 works. When the positive direct current bus BUS+ is used as an input, the switching transistor Q2 is normally switched off, and modulation control is performed on the switching transistor Q1. When the switching transistor Q1 is switched on, the positive direct current bus BUS+ stores energy to the inductor L1, the inductor L2, and the battery; and when the switching transistor Q1 is switched off, the inductor L1 and the inductor L2 freewheel through the diode D1 and diode D2 to charge the battery. When the negative direct current bus BUS− is used as an input, the switching transistor Q1 is usually switched off, and modulation control is performed on the switching transistor Q2. When the switching transistor Q2 is switched on, the negative direct current bus BUS− stores energy to the inductor L1, the inductor L2, and the battery; and when the switching transistor Q2 is switched off, the inductor L1 and the inductor L2 freewheel through the diode D1 and diode D2 to charge the battery. With reference to FIG. 3, it can be analyzed and derived that whether the positive direct current bus BUS+ is used as an input or the negative direct current bus BUS− is used as an input, since the inductor L1 and the inductor L2 are usually designed in the same manner, voltages of the inductor L1 and the inductor L2 in a process of energy storage and discharge are consistent. As a result, a voltage of the negative electrode DC− of the battery relative to the neutral line N0 in a process of modulation control of the switching transistor Q1 or the switching transistor Q2 changes at a high voltage and a high frequency. Therefore, an EMC characteristic of the circuit shown in FIG. 2 is very poor.

FIG. 4 shows a schematic diagram of a third type of DC-DC conversion circuit connected between a direct current bus and a battery. The third type of DC-DC conversion circuit can implement bidirectional DC-DC conversion between a dual direct current bus and a battery. As shown in FIG. 4, a positive direct current bus capacitor C1 and a negative direct current bus capacitor C2 that are connected in series with each other are electrically connected between a positive direct current bus BUS+ and a negative direct current bus BUS−. The circuit includes a switching transistor Q1, a switching transistor Q2, and an inductor L1. A first electrode of the switching transistor Q1 is connected to a first terminal of the inductor L1 and a second electrode of the switching transistor Q2, a second electrode of the switching transistor Q1 and a first electrode of the switching transistor Q2 are respectively connected to the positive direct current bus BUS+ and the negative direct current bus BUS−, and a first electrode of the switching transistor Q2 and a second terminal of the inductor L1 are respectively connected to the negative electrode DC− of a battery and the positive electrode DC+ of the battery. When the dual direct current bus supplies power to the battery, it is a BUCK line. When the battery supplies power to the dual direct current bus, it is a BOOST line. Similar to the circuit in FIG. 1, when the dual direct current bus of the circuit supplies power to the battery, for a single-phase mains input UPS, a direct current bus (BUS) capacitor has large ripples, and a larger BUS capacitor is required, which increases difficulty in BUS control. For a UPS with a medium or low power range, a voltage of the dual direct current bus is generally about 700 V, a voltage of the battery is a single direct current voltage of about 200 V, and a buck voltage difference is large, resulting in a low charging efficiency. When the battery of the circuit supplies power to the dual direct current bus, for a single-phase output UPS, the BUS capacitor has large ripples, and a larger BUS capacitor is required, which increases difficulty in BUS control. For the UPS with a medium or low power range, the voltage of the dual direct current bus is generally about 700 V, the voltage of the battery is a single direct current voltage of about 200 V, and a boost voltage difference is large, resulting in a low discharging efficiency. In addition, the negative electrode DC− of the battery of the circuit is connected to the negative direct current bus BUS−. Therefore, for a UPS parallel system, voltages of negative direct current buses relative to neutral lines for different machines fluctuate. Therefore, this cannot be used in a battery-sharing parallel system.

FIG. 5 shows a schematic diagram of a fourth type of DC-DC conversion circuit connected between a direct current bus and a battery. The fourth type of DC-DC conversion circuit can implement bidirectional DC-DC conversion between a dual direct current bus and a battery. As shown in FIG. 5, a positive direct current bus capacitor C1 and a negative direct current bus capacitor C2 that are connected in series with each other are electrically connected between a positive direct current bus BUS+ and a negative direct current bus BUS−, and a node between the positive direct current bus capacitor C1 and the negative direct current bus capacitor C2 is connected to a neutral line N0. The DC-DC conversion circuit includes a switching transistor Q1, a switching transistor Q2, an inductor L1, a switching transistor Q3, a switching transistor Q4, and an inductor L2. The switching transistor Q1 and the inductor L1 are sequentially connected in series between the positive direct current bus BUS+ and the positive electrode DC+ of a battery, a second electrode of the switching transistor Q1 is connected to the positive direct current bus BUS+, a first electrode of the switching transistor Q1 is connected to a first terminal of the inductor L1, and a second terminal of the inductor L1 is connected to the positive electrode DC+ of the battery. The switching transistor Q4 and the inductor L2 are sequentially connected in series between the negative direct current bus BUS− and the negative electrode DC− of the battery, a first electrode of the switching transistor Q4 is connected to the negative direct current bus BUS−, a second electrode of the switching transistor Q4 is connected to a first terminal of the inductor L2, and a second terminal of the inductor L2 is connected to the negative electrode DC− of the battery. The switching transistor Q2 and the switching transistor Q3 are connected in series between a first node N1 and a second node N2, a second electrode of the switching transistor Q2 is connected to the first node N1, a first electrode of the switching transistor Q2 is connected to a second electrode of the switching transistor Q3, a first electrode of the switching transistor Q3 is connected to the second node N2, the first node N1 is located between the switching transistor Q1 and the inductor L1, and the second node N2 is located between the switching transistor Q4 and the inductor L2. The first electrode of the switching transistor Q2 and the second electrode of the switching transistor Q3 are separately connected to the neutral line N0.

A working process of the circuit shown in FIG. 5 is as follows:

When the positive direct current bus BUS+ is used as an input to charge the battery, the switching transistor Q4 is normally switched on, the switching transistor Q3 is normally switched off, and the switching transistor Q1, the switching transistor Q2, the inductor L1, and the inductor L2 form a BUCK line. When the negative direct current bus BUS− is used as an input to charge the battery, the switching transistor Q1 is normally switched on, the switching transistor Q2 is normally switched off, and the switching transistor Q3, the switching transistor Q4, the inductor L1, and the inductor L2 form a BUCK line.

When the battery is used as an input to supply power to the positive direct current bus BUS+, the switching transistor Q4 is normally switched off, the switching transistor Q3 is normally switched on, and the switching transistor Q1, the switching transistor Q2, the inductor L1, and the inductor L2 form a BOOST line. When the battery is used as an input to supply power to the negative direct current bus BUS−, the switching transistor Q1 is normally switched off, the switching transistor Q2 is normally switched on, and the switching transistor Q3, the switching transistor Q4, the inductor L1, and the inductor L2 form a BOOST line.

Based on the foregoing working process, it can be concluded that the voltages of the positive electrode and the negative electrode of the battery relative to the neutral line N0 change at a high frequency, which results in a very poor EMC characteristic of the circuit. Therefore, this control manner of the circuit cannot be used in a battery-sharing parallel system.

To resolve the problems appearing in the foregoing circuit, a DC-DC conversion circuit is provided according to some embodiments of the present inventive concept. The DC-DC conversion circuit includes a positive direct current bus, a negative direct current bus, a rechargeable direct current power supply (that is, a battery), and a direct current conversion unit. A positive direct current bus capacitor and a negative direct current bus capacitor that are connected in series with each other are electrically connected between the positive direct current bus and the negative direct current bus, and a node between the positive direct current bus capacitor and the negative direct current bus capacitor is connected to a neutral line. The negative electrode of the battery is connected to the neutral line. The direct current conversion unit includes a first semiconductor switching device, a second semiconductor switching device, a third semiconductor switching device, a fourth semiconductor switching device, and a first inductor. Two terminals of the first semiconductor switching device are respectively connected to the positive direct current bus and a first terminal of the first inductor, two terminals of the fourth semiconductor switching device are respectively connected to a second terminal of the first inductor and a positive electrode of the battery, two terminals of the second semiconductor switching device are respectively connected to the first terminal of the first inductor and the neutral line, and two terminals of the third semiconductor switching device are respectively connected to the second terminal of the first inductor and the negative direct current bus. The positive direct current bus and the negative direct current bus charge the battery through the direct current conversion unit, and/or the battery supplies power to the positive direct current bus and the negative direct current bus through the direct current conversion unit.

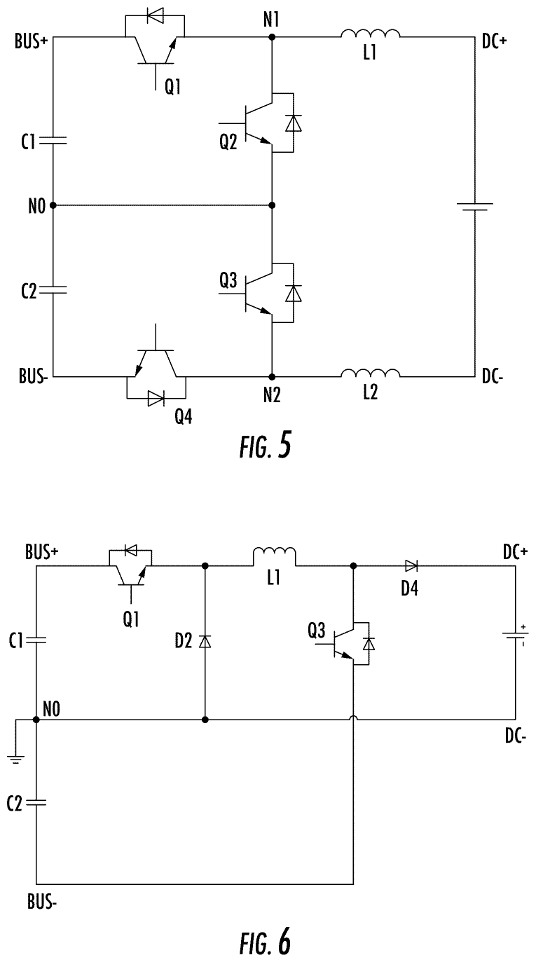

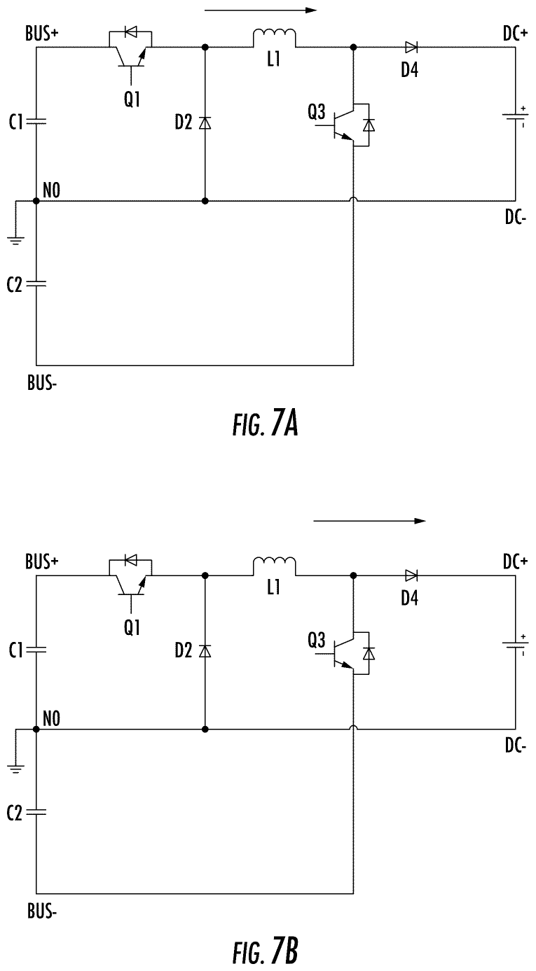

As shown in FIG. 6, in an embodiment, the DC-DC conversion circuit includes: a positive direct current bus capacitor C1 and a negative direct current bus capacitor C2 that are connected in series with each other and are electrically connected between a positive direct current bus BUS+ and a negative direct current bus BUS−, wherein a node between the positive direct current bus capacitor C1 and the negative direct current bus capacitor C2 is connected to a neutral line N0. The neutral line N0 is connected to the negative electrode DC− of the battery. The first semiconductor switching device and the third semiconductor switching device of the direct current conversion unit are controllable semiconductor switching devices with anti-parallel diodes (in this embodiment, the first semiconductor switching device and the third semiconductor switching device are respectively shown as Q1 and Q3 in FIG. 6), and the second semiconductor switching device and the fourth semiconductor switching device are diodes (in this embodiment, the second semiconductor switching device and the fourth semiconductor switching device are respectively shown as D2 and D4 in FIG. 6). A first electrode of the controllable semiconductor switching device Q1 is connected to a first terminal of the first inductor L1, a second terminal of the first inductor L1 is connected to an anode of the diode D4, a second electrode of the controllable semiconductor switching device Q1 is connected to the positive direct current bus BUS+, and a cathode of the diode D4 is connected to the positive electrode DC+ of the battery. A first electrode of the controllable semiconductor switching device Q3 is connected to the negative direct current bus BUS−, and a second electrode of the controllable semiconductor switching device Q3 is connected to the second terminal of the first inductor L1. An anode of the diode D2 is connected to the neutral line N0, and a cathode of the diode D2 is connected to the first terminal of the first inductor L1.

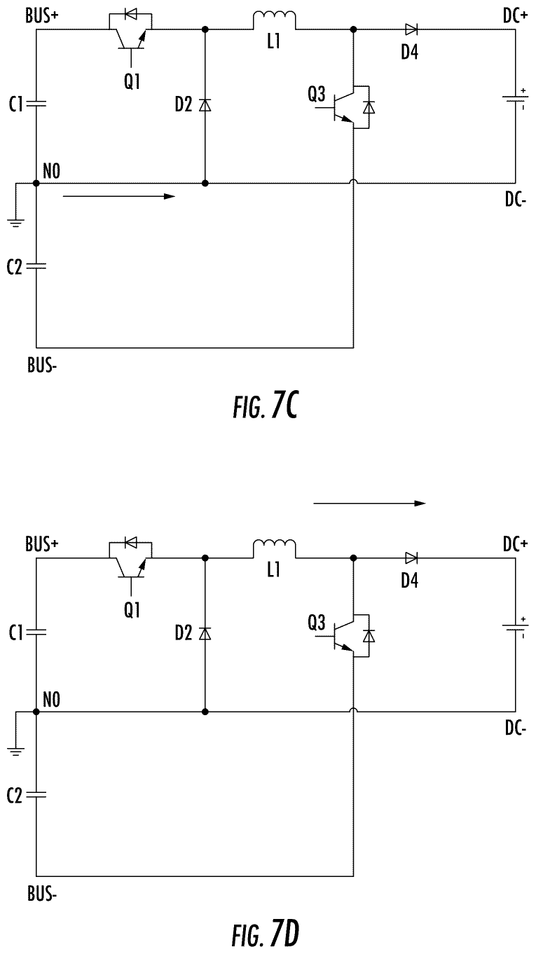

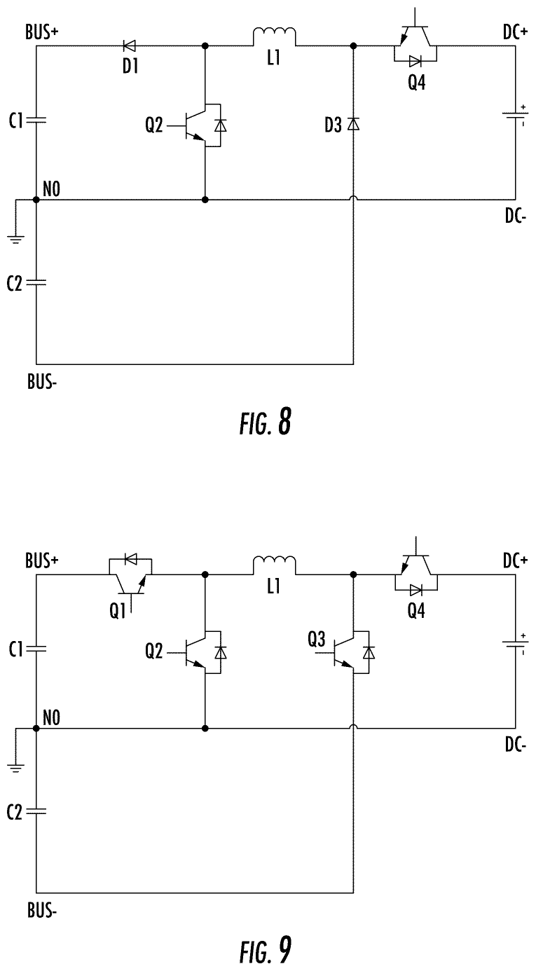

FIG. 7A and FIG. 7B respectively show schematic diagrams of equivalent circuits corresponding to that a direct current bus stores energy to an inductor and charges a battery (FIG. 7A) and that the inductor charges the battery (FIG. 7B) when a positive direct current bus BUS+ of the circuit topology in the embodiment shown in FIG. 6 is used as an input. When the positive direct current bus BUS+ is used as an input, the controllable semiconductor switching device Q3 is normally switched off, and modulation control is performed on the controllable semiconductor switching device Q1. As shown in FIG. 7A, when the controllable semiconductor switching device Q1 is switched on, a current path is as follows: the positive direct current bus BUS+→ the controllable semiconductor switching device Q1→ the inductor L1→ the diode D4→ the positive electrode DC+ of the battery→ the negative electrode DC− of the battery→ the neutral line N0, and the positive direct current bus BUS+ stores energy to the inductor L1 and the battery. As shown in FIG. 7B, when the controllable semiconductor switching device Q1 is switched off, a current path is as follows: the inductor L1→ the diode D4→ the positive electrode DC+ of the battery→ the negative electrode DC− of the battery→ the diode D2, and the inductor L1 freewheels through the diode D2 and the diode D4 to charge the battery.

FIG. 7C and FIG. 7D respectively show schematic diagrams of equivalent circuits corresponding to that a direct current bus stores energy to an inductor (FIG. 7C) and that the inductor charges a battery (FIG. 7D) when a negative direct current bus BUS− of the circuit topology in the embodiment shown in FIG. 6 is used as an input. When the negative direct current bus BUS− is used as an input, the controllable semiconductor switching device Q1 is normally switched off, and modulation control is performed on the controllable semiconductor switching device Q3. As shown in FIG. 7C, when the controllable semiconductor switching device Q3 is on, a current path is as follows: the neutral line N0→ the diode D2→ the inductor L1→ the controllable semiconductor switching device Q3→ the negative direct current bus BUS−, and the negative direct current bus BUS− stores energy to the inductor L1. As shown in FIG. 7D, when the controllable semiconductor switching device Q3 is switched off, a current path is as follows: the inductor L1→ the diode D4→ the positive electrode DC+ of the battery→ the negative electrode DC− of the battery→ the diode D2, and the inductor L1 freewheels through the diode D2 and the diode D4 to charge the battery.

Compared with the circuit topology in FIG. 1, the input of the circuit topology in FIG. 6 is a single-side direct current bus, which is more suitable for application to a single-phase alternating current mains input UPS. In addition, a voltage difference between two terminals of a buck circuit is small, and efficiency is high. Compared with the circuit topology in FIG. 2, when a single-side direct current bus is used as an input in the circuit topology in FIG. 6, the negative electrode DC− of the battery is directly connected to the neutral line N0. Therefore, an EMC characteristic of the circuit is good, and can be used in a battery-sharing parallel system of a single-battery UPS. In addition, the circuit has only one inductor, which can save costs and space.

In an embodiment, the first semiconductor switching device and the third semiconductor switching device of the direct current conversion unit of the DC-DC conversion circuit are diodes (in this embodiment, the first semiconductor switching device and the third semiconductor switching device are respectively shown as D1 and D3 in FIG. 8), and the second semiconductor switching device and the fourth semiconductor switching device are controllable semiconductor switching devices with anti-parallel diodes (in this embodiment, the second semiconductor switching device and the fourth semiconductor switching device are respectively shown as Q2 and Q4 in FIG. 8). As shown in FIG. 8, an anode of the diode D1 is connected to the first terminal of the first inductor L1, the second terminal of the inductor L1 is connected to the first electrode of the controllable semiconductor switching device Q4, a cathode of the diode D1 is connected to the positive direct current bus BUS+, and a second electrode of the controllable semiconductor switching device Q4 is connected to the positive electrode DC+ of the battery. An anode of the diode D3 is connected to the negative direct current bus BUS−, and a cathode of the diode D3 is connected to the second terminal of the first inductor L1. A first electrode of the controllable semiconductor switching device Q2 is connected to the neutral line N0, and a second electrode of the controllable semiconductor switching device Q2 is connected to the first terminal of the first inductor L1. A working process of the DC-DC conversion circuit is as follows:

The battery supplies power to the positive direct current bus: The controllable semiconductor switching device Q4 is normally switched on, and modulation control is performed on the controllable semiconductor switching device Q2. When the controllable semiconductor switching device Q2 is switched on, a current path is formed between the battery, the controllable semiconductor switching device Q4, the inductor L1, and the controllable semiconductor switching device Q2, and the battery stores energy to the inductor L1; and when the controllable semiconductor switching device Q2 is switched off, a current path is formed between the battery, the controllable semiconductor switching device Q4, the inductor L1, the diode D1, the positive direct current bus BUS+, and the neutral line N0, and the inductor L1 freewheels to supply power to the positive direct current bus BUS+ through the diode D1.

The battery supplies power to the negative direct current bus: The controllable semiconductor switching device Q2 is normally switched on, and modulation control is performed on the controllable semiconductor switching device Q4. When the controllable semiconductor switching device Q4 is switched on, a current path is formed between the battery, the controllable semiconductor switching device Q4, the inductor L1, and the controllable semiconductor switching device Q2, and the battery stores energy to the inductor L1; and when the controllable semiconductor switching device Q4 is switched off, a current path is formed between the inductor L1, the controllable semiconductor switching device Q2, the neutral line N0, the negative direct current bus BUS−, and the diode D3, and the inductor L1 supplies power to the negative direct current bus BUS− through the diode D3.

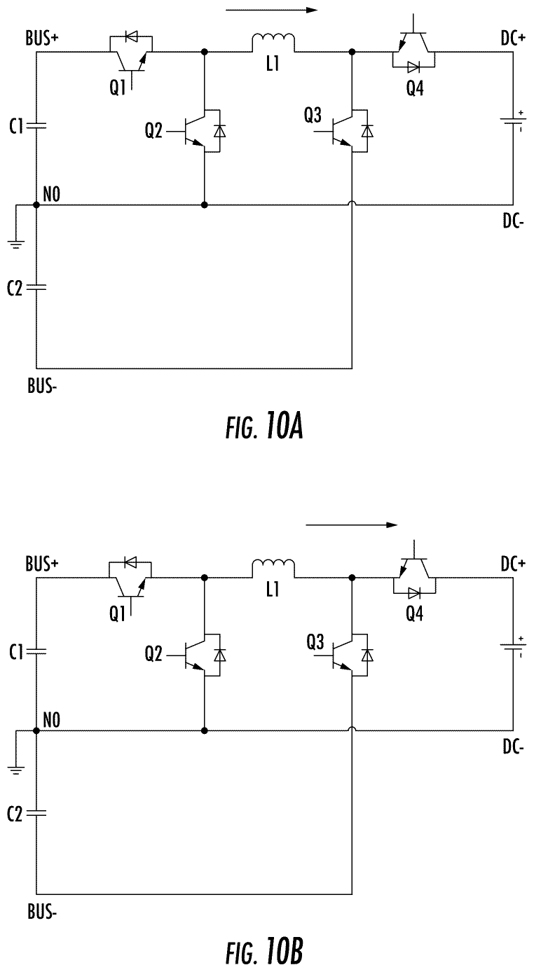

In an embodiment, the first semiconductor switching device, the second semiconductor switching device, the third semiconductor switching device, and the fourth semiconductor switching device of the direct current conversion unit of the DC-DC conversion circuit are all controllable semiconductor switching devices with anti-parallel diodes (in this embodiment, the first semiconductor switching device, the second semiconductor switching device, the third semiconductor switching device, and the fourth semiconductor switching device are respectively shown as Q1, Q2, Q3, and Q4 in FIG. 9). As shown in FIG. 9, the first electrode of the controllable semiconductor switching device Q1 is connected to the first terminal of the first inductor L1, the second terminal of the first inductor L1 is connected to the first electrode of the controllable semiconductor switching device Q4, the second electrode of the controllable semiconductor switching device Q1 is connected to the positive direct current bus BUS+, and the second electrode of the controllable semiconductor switching device Q4 is connected to the positive electrode DC+ of the battery. The first electrode of the controllable semiconductor switching device Q3 is connected to the negative direct current bus BUS−, and the second electrode of the controllable semiconductor switching device Q3 is connected to the second terminal of the first inductor L1. The first electrode of the controllable semiconductor switching device Q2 is connected to the neutral line N0, and the second electrode of the controllable semiconductor switching device Q2 is connected to the first terminal of the first inductor L1.

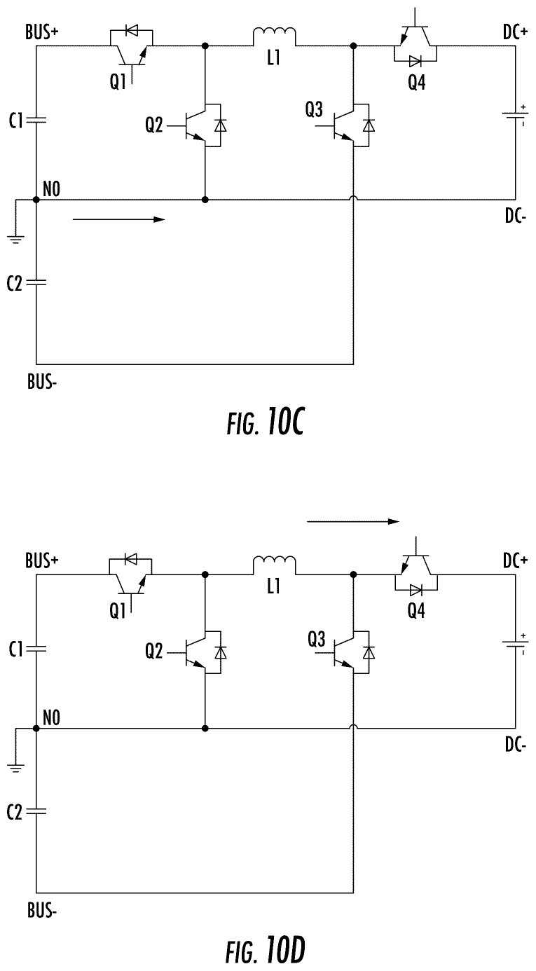

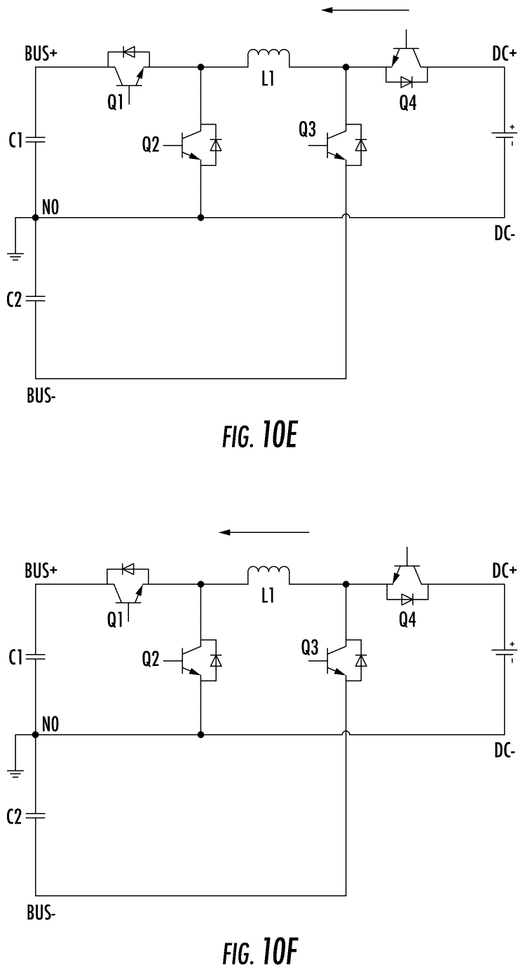

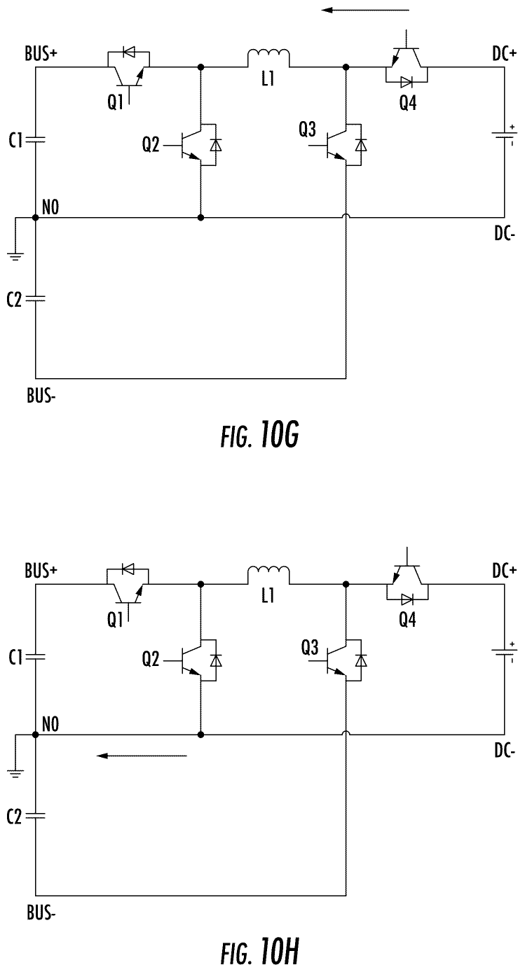

FIG. 10A and FIG. 10B respectively show schematic diagrams of equivalent circuits corresponding to that a positive direct current bus BUS+ stores energy to an inductor and charges a battery (FIG. 10A) and that the inductor charges the battery (FIG. 10B) when a direct current bus of the circuit topology in the embodiment shown in FIG. 9 charges the battery. When the positive direct current bus BUS+ is used as an input, in manner 1: The controllable semiconductor switching device Q3 is normally switched off, the controllable semiconductor switching device Q4 is normally switched on, and complementary modulation control is performed on the controllable semiconductor switching device Q1 and the controllable semiconductor switching device Q2. As shown in FIG. 10A, when the controllable semiconductor switching device Q1 is switched on, and the controllable semiconductor switching device Q2 is switched off, a current path is as follows: the positive direct current bus BUS+→ the controllable semiconductor switching device Q1→ the inductor L1→ the controllable semiconductor switching devices Q4→ the positive electrode DC+ of the battery→ the negative electrode DC− of the battery→ the neutral line N0, and the positive direct current bus BUS+ stores energy to the inductor L1 and the battery. As shown in FIG. 10B, when the controllable semiconductor switching device Q1 is switched off, and the controllable semiconductor switching device Q2 is switched on, a current path is as follows: the inductor L1→ the controllable semiconductor switching device Q4→ the positive electrode DC+ of the battery→ the negative electrode DC− of the battery→ the controllable semiconductor switching device Q2, and the inductor L1 can charge the battery. In manner 2: The controllable semiconductor switching device Q2, the controllable semiconductor switching device Q3, and the controllable semiconductor switching device Q4 are normally switched off, and modulation control is performed on the controllable semiconductor switching device Q1. When the controllable semiconductor switching device Q1 is switched on, referring to FIG. 10A, a current path is as follows: the positive direct current bus BUS+→ the controllable semiconductor switching device Q1→ the inductor L1→ the controllable semiconductor switching device Q4→ the positive electrode DC+ of the battery→ the negative electrode DC− of the battery→ the neutral line N0, and the positive direct current bus BUS+ stores energy to the inductor L1 and the battery. When the controllable semiconductor switching device Q1 is switched off, referring to FIG. 10B, a current path is as follows: the inductor L1→ the controllable semiconductor switching device Q4→ the positive electrode DC+ of the battery→ the negative electrode DC− of the battery→ the controllable semiconductor switching device Q2, and the inductor L1 can freewheel through freewheeling diodes in the controllable semiconductor switching device Q2 and the controllable semiconductor switching device Q4 to charge the battery.

FIG. 10C and FIG. 10D respectively show schematic diagrams of equivalent circuits corresponding to that a negative direct current bus BUS− stores energy to an inductor (FIG. 10C) and that the inductor charges a battery (FIG. 10D) when a direct current bus of the circuit topology in the embodiment shown in FIG. 9 charges the battery. When the negative direct current bus BUS− is used as an input, in manner 1: The controllable semiconductor switching device Q1 is normally switched off, the controllable semiconductor switching device Q2 is normally switched on, and complementary modulation control is performed on the controllable semiconductor switching device Q3 and the controllable semiconductor switching device Q4. As shown in FIG. 10C, when the controllable semiconductor switching device Q3 is switched on, and the controllable semiconductor switching device Q4 is switched off, a current path is as follows: the neutral line N0→ the controllable semiconductor switching device Q2→ the inductor L1→ the controllable semiconductor switching device Q3→ the negative direct current bus BUS−, and the negative direct current bus BUS− stores energy to the inductor L1. As shown in FIG. 10D, when the controllable semiconductor switching device Q3 is switched off, and the controllable semiconductor switching device Q4 is switched on, a current path is as follows: the inductor L1→ the controllable semiconductor switching device Q4→ the positive electrode DC+ of the battery→ the negative electrode DC− of the battery→ the controllable semiconductor switching device Q2, and the inductor L1 can charge the battery. In manner 2: The controllable semiconductor switching device Q1, the controllable semiconductor switching device Q2, and the controllable semiconductor switching device Q4 are normally switched off, and modulation control is performed on the controllable semiconductor switching device Q3. When the controllable semiconductor switching device Q3 is switched on, referring to FIG. 10C, a current path is as follows: the neutral line N0→ the controllable semiconductor switching device Q2→ the inductor L1→ the controllable semiconductor switching device Q3→ the negative direct current bus BUS−, and the negative direct current bus BUS− stores energy to the inductor L1. When the controllable semiconductor switching device Q3 is switched off, referring to FIG. 10D, a current path is as follows: the inductor L1→ the controllable semiconductor switching device Q4→ the positive electrode DC+ of the battery→ the negative electrode DC− of the battery→ the controllable semiconductor switching device Q2, and the inductor L1 can freewheel through freewheeling diodes in the controllable semiconductor switching device Q2 and the controllable semiconductor switching device Q4 to charge the battery.

FIG. 10E and FIG. 10F respectively show schematic diagrams of equivalent circuits corresponding to that a battery stores energy to an inductor (FIG. 10C) and that the inductor supplies power to a positive direct current bus BUS+ (FIG. 10D) when the battery of the circuit topology in the embodiment shown in FIG. 9 supplies power to a direct current bus. When the battery supplies power to the positive direct current bus BUS+, in manner 1: The controllable semiconductor switching device Q3 is normally switched off, the controllable semiconductor switching device Q4 is normally switched on, and complementary modulation control is performed on the controllable semiconductor switching device Q1 and the controllable semiconductor switching device Q2. As shown in FIG. 10E, when the controllable semiconductor switching device Q1 is switched off, and the controllable semiconductor switching device Q2 is switched on, a current path is as follows: the positive electrode DC+ of the battery→ the controllable semiconductor switching device Q4→ the inductor L1→ the controllable semiconductor switching device Q2→ the negative electrode DC− of the battery, and the battery stores energy to the inductor L1. As shown in FIG. 10F, when the controllable semiconductor switching device Q1 is switched on, and the controllable semiconductor switching device Q2 is switched off, a current path is as follows: the inductor L1→ the controllable semiconductor switching device Q1→ the positive direct current bus BUS+→ the neutral line N0→ the negative electrode DC− of the battery→ the positive electrode DC+ of the battery→ the controllable semiconductor switching device Q4→ the inductor L1, and the inductor L1 can supply power to the positive direct current bus BUS+. In manner 2: The controllable semiconductor switching device Q4 is normally switched on, the controllable semiconductor switching device Q1 and the controllable semiconductor switching device Q3 are normally switched off, and modulation control is performed on the controllable semiconductor switching device Q2. When the controllable semiconductor switching device Q2 is switched on, referring to FIG. 10E, a current path is follows: the positive electrode DC+ of the battery→ the controllable semiconductor switching device Q4→ the inductor L1→ the controllable semiconductor switching device Q2→ the negative electrode DC− of the battery, and the battery stores energy to the inductor L1. When the controllable semiconductor switching device Q2 is switched off, referring to FIG. 10F, a current path is as follows: the inductor L1→ the controllable semiconductor switching device Q1→ the positive direct current busbar BUS+→ the neutral line N0→ the negative electrode DC− of the battery→ the positive electrode DC+ of the battery→ the controllable semiconductor switching device Q4→ the inductor L1; and the inductor L1 can freewheel through a freewheeling diode in the controllable semiconductor switching device Q1 to supply power to the positive direct current bus BUS+.

FIG. 10G and FIG. 10H respectively show schematic diagrams of equivalent circuits corresponding to that a battery stores energy to an inductor (FIG. 10G) and that the inductor supplies power to a negative direct current bus BUS− (FIG. 10D) when the battery of the circuit topology in the embodiment shown in FIG. 9 supplies power to a direct current bus. When the battery supplies power to the negative direct current bus BUS−, in manner 1: The controllable semiconductor switching device Q1 is normally switched off, the controllable semiconductor switching device Q2 is normally switched on, and complementary modulation control is performed on the controllable semiconductor switching device Q3 and the controllable semiconductor switching device Q4. As shown in FIG. 10G, when the controllable semiconductor switching device Q3 is switched off, and the controllable semiconductor switching device Q4 is switched on, a current path is as follows: the positive electrode DC+ of the battery→ the controllable semiconductor switching device Q4→ the inductor L1→ the controllable semiconductor switching device Q2→ the negative electrode DC− of the battery, and the battery stores energy to the inductor L1. As shown in FIG. 10H, when the controllable semiconductor switching device Q3 is switched on and the controllable semiconductor switching device Q4 is switched off, a current path is as follows: the inductor L1→ the controllable semiconductor switching device Q2→ the neutral line N0→ the negative direct current bus BUS− → the controllable semiconductor switching device Q3→ the inductor L1, and the inductor L1 can supply power to the negative direct current bus BUS−. In manner 2: The controllable semiconductor switching device Q2 is normally switched on, the controllable semiconductor switching device Q1 and the controllable semiconductor switching device Q3 are normally switched off, and modulation control is performed on the controllable semiconductor switching device Q4. When the controllable semiconductor switching device Q4 is switched on, referring to FIG. 10G, a current path is follows: the positive electrode DC+ of the battery→ the controllable semiconductor switching device Q4→ the inductor L1→ the controllable semiconductor switching device Q2→ the negative electrode DC− of the battery; and the battery stores energy to the inductor L1. When the controllable semiconductor switching device Q4 is switched off, referring to FIG. 10H, a current path is as follows: the inductor L1→ the controllable semiconductor switching device Q2→ the neutral line N0→ the negative direct current bus BUS− → the controllable semiconductor switching device Q3→ the inductor L1, and the inductor L1 can freewheel through a freewheeling diode in the controllable semiconductor switching device Q3 to supply power to the negative direct current bus BUS−.

Compared with the circuit topology in FIG. 4, only a single-side bus in the dual direct current bus of the circuit topology in FIG. 9 works, which is more suitable for a single-phase alternating current mains input UPS, and a voltage difference between voltages of two sides is small, and efficiency is high. Compared with the circuit topology in FIG. 5, the negative electrode DC− of the battery in the circuit topology in FIG. 9 is directly connected to the neutral line N0. Therefore, an EMC characteristic of the circuit is good, and can be used in a battery-sharing parallel system of a single-battery UPS. In addition, the circuit has only one inductor, which can save costs and space.

An embodiment of the present inventive concept further provides a DC-DC conversion circuit, including a positive direct current bus, a negative direct current bus, a battery, and a direct current conversion unit. A positive direct current bus capacitor C1 and a negative direct current bus capacitor C2 that are connected in series with each other are electrically connected between the positive direct current bus BUS+ and the negative direct current bus BUS−, and a node between the positive direct current bus capacitor C1 and the negative direct current bus capacitor C2 is connected to a neutral line N0. The positive electrode DC+ of the battery is connected to the neutral line N0. The direct current conversion unit includes a first semiconductor switching device, a second semiconductor switching device, a third semiconductor switching device, a fourth semiconductor switching device, and a first inductor. Two terminals of the first semiconductor switching device are respectively connected to the negative direct current bus BUS− and a first terminal of the first inductor L1, two terminals of the fourth semiconductor switching device are respectively connected to a second terminal of the first inductor L1 and the negative electrode DC− of the battery, two terminals of the second semiconductor switching device are respectively connected to the first terminal of the first inductor L1 and the neutral line N0, and two terminals of the third semiconductor switching device are respectively connected to the second terminal of the first inductor L1 and the positive direct current bus BUS+. The positive direct current bus BUS+ and the negative direct current bus BUS− charge the battery through the direct current conversion unit, and/or the battery supplies power to the positive direct current bus BUS+ and the negative direct current bus BUS− through the direct current conversion unit.

In an embodiment, the first semiconductor switching device and the third semiconductor switching device of the direct current conversion unit of the DC-DC conversion circuit are controllable semiconductor switching devices with anti-parallel diodes (in this embodiment, the first semiconductor switching device and the third semiconductor switching device are respectively shown as Q1 and Q3 in FIG. 11), and the second semiconductor switching device and the fourth semiconductor switching device are diodes (in this embodiment, the second semiconductor switching device and the fourth semiconductor switching device are respectively shown as D2 and D4 in FIG. 11). As shown in FIG. 11, a second electrode of the controllable semiconductor switching device Q1 is connected to the first terminal of the first inductor L1, the second terminal of the first inductor L1 is connected to a cathode of the diode D4, a first electrode of the controllable semiconductor switching device Q1 is connected to the negative direct current bus BUS−, and an anode of the diode D4 is connected to the negative electrode DC− of the battery. A second electrode of the controllable semiconductor switching device Q3 is connected to the positive direct current bus BUS+, and a first electrode of the controllable semiconductor switching device Q3 is connected to the second terminal of the first inductor L1. A cathode of the diode D2 is connected to the neutral line N0, and an anode of the diode D2 is connected to the first terminal of the first inductor L1. The controllable semiconductor switching device Q1 is configured to be alternately switched on, the controllable semiconductor switching device Q3 is configured to be switched off, and the negative direct current bus BUS− charges the battery. The controllable semiconductor switching device Q1 is configured to be switched off, the controllable semiconductor switching device Q3 is configured to be alternately switched on, and the positive direct current bus BUS+ charges the battery. The DC-DC conversion circuit in FIG. 11 and the DC-DC conversion circuit shown in FIG. 6 are mutually mirrored. Therefore, a principle of a working control process of the DC-DC conversion circuit in FIG. 11 is similar to that of the DC-DC conversion circuit shown in FIG. 6. Details are not described herein again.

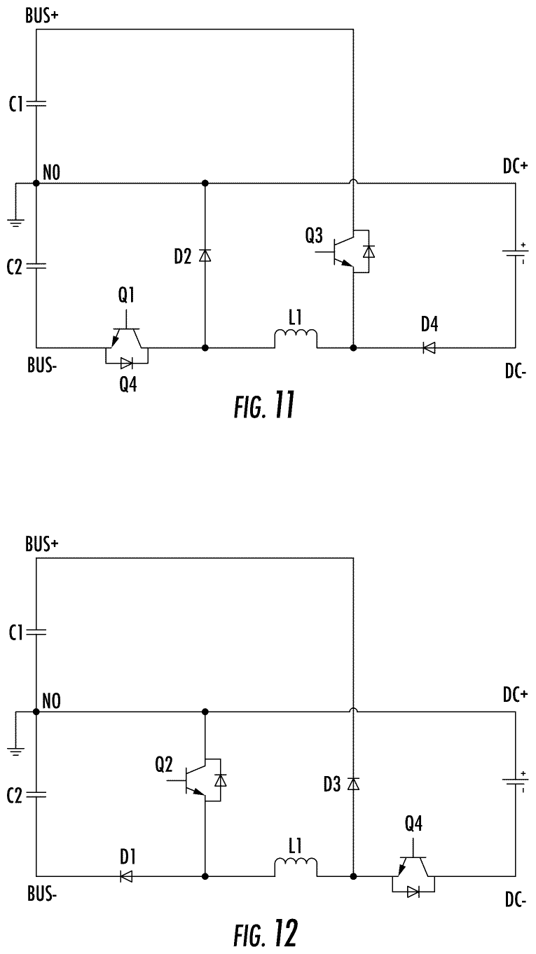

In some embodiments, the first semiconductor switching device and the third semiconductor switching device of the direct current conversion unit are diodes (in this embodiment, the first semiconductor switching device and the third semiconductor switching device are respectively shown as D1 and D3 in FIG. 12), and the second semiconductor switching device and the fourth semiconductor switching device are controllable semiconductor switching devices with anti-parallel diodes (in this embodiment, the second semiconductor switching device and the fourth semiconductor switching device are respectively shown as Q2 and Q4 in FIG. 12). As shown in FIG. 12, an anode of the diode D1 is connected to the first terminal of the first inductor L1, the second terminal of the first inductor L1 is connected to a second electrode of the controllable semiconductor switching device Q4, a cathode of the diode D1 is connected to the negative direct current bus BUS−, and a first electrode of the controllable semiconductor switching device Q4 is connected to the negative electrode DC− of the battery. A cathode of the diode D3 is connected to the positive direct current bus BUS+, and an anode of the diode D3 is connected to the second terminal of the first inductor L1. A first electrode of the controllable semiconductor switching device Q2 is connected to the neutral line N0, and a second electrode of the controllable semiconductor switching device Q2 is connected to the first terminal of the first inductor L1. The controllable semiconductor switching device Q2 is configured to be alternately switched on, the controllable semiconductor switching device Q4 is configured to be switched on, and the battery supplies power to the negative direct current bus BUS−. The controllable semiconductor switching device Q2 is configured to be switched on, the controllable semiconductor switching device Q4 is configured to be alternately switched on, and the battery supplies power to the positive direct current bus BUS+. The DC-DC conversion circuit shown in FIG. 12 and the DC-DC conversion circuit shown in FIG. 8 are mutually mirrored. Therefore, a principle of a working control process of the DC-DC conversion circuit in FIG. 12 is similar to that of the DC-DC conversion circuit shown in FIG. 8. Details are not described herein again.

In some embodiments, the first semiconductor switching device, the second semiconductor switching device, the third semiconductor switching device, and the fourth semiconductor switching device of the direct current conversion unit are all controllable semiconductor switching devices with anti-parallel diodes (in this embodiment, the first semiconductor switching device, the second semiconductor switching device, the third semiconductor switching device, and the fourth semiconductor switching device are respectively shown as Q1, Q2, Q3, and Q4 in FIG. 13). As shown in FIG. 13, the second electrode of the controllable semiconductor switching device Q1 is connected to the first terminal of the first inductor L1, the second terminal of the first inductor L1 is connected to the second electrode of the controllable semiconductor switching device Q4, the first electrode of the controllable semiconductor switching device Q1 is connected to the negative direct current bus BUS−, and the first electrode of the controllable semiconductor switching device Q4 is connected to the negative electrode DC− of the battery. The second electrode of the controllable semiconductor switching device Q3 is connected to the positive direct current bus BUS+, and the first electrode of the controllable semiconductor switching device Q3 is connected to the second terminal of the first inductor L1. The second electrode of the controllable semiconductor switching device Q2 is connected to the neutral line N0, and the first electrode of the controllable semiconductor switching device Q2 is connected to the first terminal of the first inductor L1. The controllable semiconductor switching device Q1 is configured to be alternately switched on, the controllable semiconductor switching device Q2, the controllable semiconductor switching device Q3, and the controllable semiconductor switching device Q4 are configured to be switched off, and the negative direct current bus BUS− charges the battery. The controllable semiconductor switching device Q3 is configured to be alternately switched on, the controllable semiconductor switching device Q1, the controllable semiconductor switching device Q2, and the controllable semiconductor switching device Q4 are configured to be switched off, and the positive direct current bus BUS+ charges the battery. The controllable semiconductor switching device Q4 is configured to be switched on, the controllable semiconductor switching device Q2 is configured to be alternately switched on, the controllable semiconductor switching device Q1 and the controllable semiconductor switching device Q3 are configured to be switched off, and the battery supplies power to the negative direct current bus BUS−. The controllable semiconductor switching device Q4 is configured to be alternately switched on, the controllable semiconductor switching device Q2 is configured to be switched on, the controllable semiconductor switching device Q1 and the controllable semiconductor switching device Q3 are configured to be switched off, and the battery supplies power to the positive direct current bus BUS+. The DC-DC conversion circuit in FIG. 13 and the DC-DC conversion circuit shown in FIG. 9 are mutually mirrored. Therefore, a principle of a working control process of the DC-DC conversion circuit in FIG. 13 is similar to that of the DC-DC conversion circuit shown in FIG. 9. Details are not described herein again.

A UPS generally has a mains supply mode and a battery mode, and has a dual direct current bus inside. In the mains supply mode, the mains supply supplies power to the dual direct current bus, and a battery needs to be charged by a charging circuit. For a battery charger with slightly higher power, the dual direct current bus of the UPS is generally used as an input of the charger. In the battery mode, the battery supplies power to the dual direct current bus. For a UPS with a medium or low power range, the battery is generally a single battery with a rated voltage of about 200 V. The UPS generally has a parallel operation capability. To save costs, customers tend to share a battery in a parallel operation. For a single-battery UPS, when a conversion circuit commonly used between the mains supply, a battery, and a dual-direct current bus is charged or discharged, a voltage of a terminal of a battery relative to a potential of neutral lines of a system fluctuates, so that an EMC characteristic of the system is poor. In addition, for a UPS parallel system, because neutral lines of UPS systems are shorted together, and a voltage of the positive electrode and the negative electrode of a battery relative to a neutral line of an existing circuit fluctuates, it is impossible to implement battery sharing during parallel operation of a plurality of UPSs.

Based on the foregoing problem, an embodiment of the present inventive concept provides a power conversion circuit, including a first switch S1, a rectifier unit, and a DC-DC conversion circuit according to any one of the foregoing embodiments of the present inventive concept. A first terminal of the first switch S1 is connected to the mains supply, a second terminal of the first switch is connected to an input terminal of the rectifier unit, and an output terminal of the rectifier unit is connected to a positive direct current bus BUS+, a negative direct current bus BUS−, and a neutral line N0. The following uses the DC-DC conversion circuit shown in FIG. 9 as an example to describe the power conversion circuit in detail.

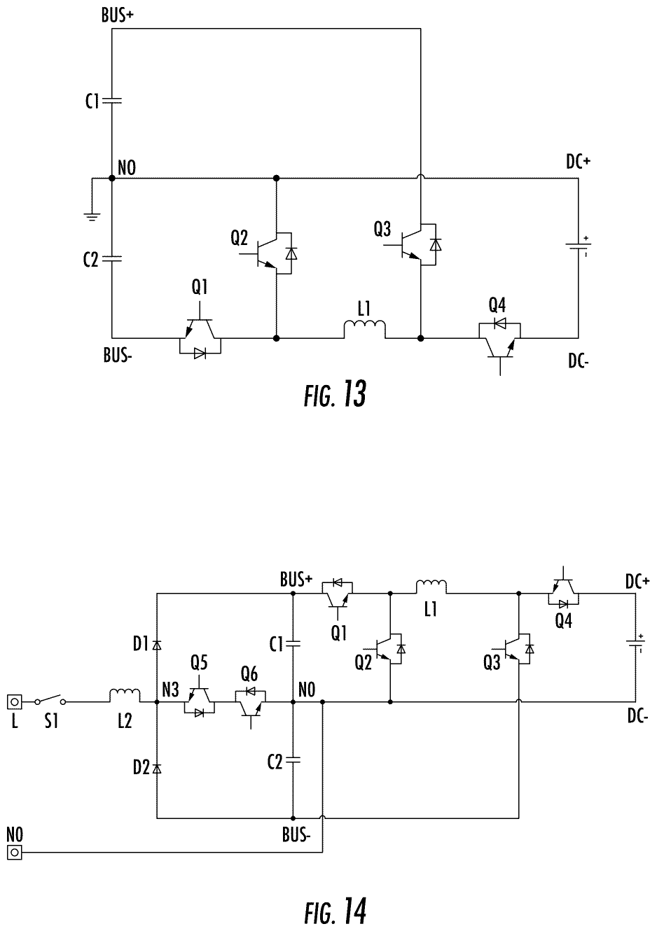

As shown in FIG. 14, in an embodiment, the power conversion circuit includes a first switch S1, a rectifier unit (or PFC unit), and a DC-DC conversion circuit. Components and a connection relationship between the components in the DC-DC conversion circuit are the same as those in the DC-DC conversion circuit shown in FIG. 9. Details are not described herein again. The rectifier unit includes a second inductor L2, a third node N3, a first branch, a second branch, and a third branch. A first terminal of the second inductor L2 is connected to the mains supply L through the first switch S1, and a second terminal of the second inductor L2 is connected to the third node N3. The first branch includes a diode D1 configured to control conduction between the third node N3 and the positive direct current bus BUS+. An anode of the diode D1 is connected to the third node N3, and a cathode of the diode D1 is connected to the positive direct current bus BUS+. The second branch includes a controllable semiconductor switching device Q5 and a controllable semiconductor switching device Q6 in reverse series connection with the controllable semiconductor switching device Q5. In this embodiment of the present inventive concept, as shown in FIG. 14, the two controllable semiconductor switching devices Q5 and Q6 each are provided with a freewheeling diode, and the reverse series connection between the two controllable semiconductor switching devices refers to that two controllable semiconductor switching devices of the same type are connected in a reverse manner. For example, a second electrode of the controllable semiconductor switching device Q5 is connected to a second electrode of the controllable semiconductor switching device Q6, and a purpose of the reverse series connection is to prevent conduction implemented through two freewheeling diodes. The controllable semiconductor switching device Q5 and the controllable semiconductor switching device Q6 are configured to control unidirectional conduction between the third node N3 and the neutral line N0. The second electrode of the controllable semiconductor switching device Q5 is connected to the second electrode of the controllable semiconductor switching device Q6, a first electrode of the controllable semiconductor switching device Q5 is connected to the third node N3, and a first electrode of the controllable semiconductor switching device Q6 is connected to the neutral line NO. The third branch includes a diode D2 configured to control conduction between the third node N3 and the negative direct current bus BUS−. A cathode of diode D2 is connected to the third node N3 and an anode of diode D2 is connected to the negative direct current bus BUS−.

When the circuit shown in FIG. 14 is in a mains supply mode, the first switch S1 is turned on.

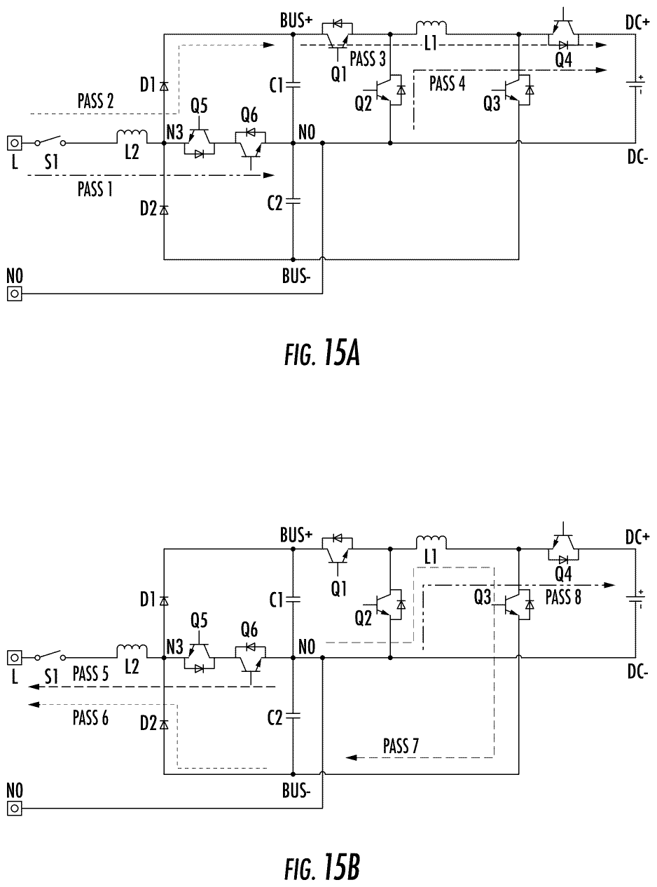

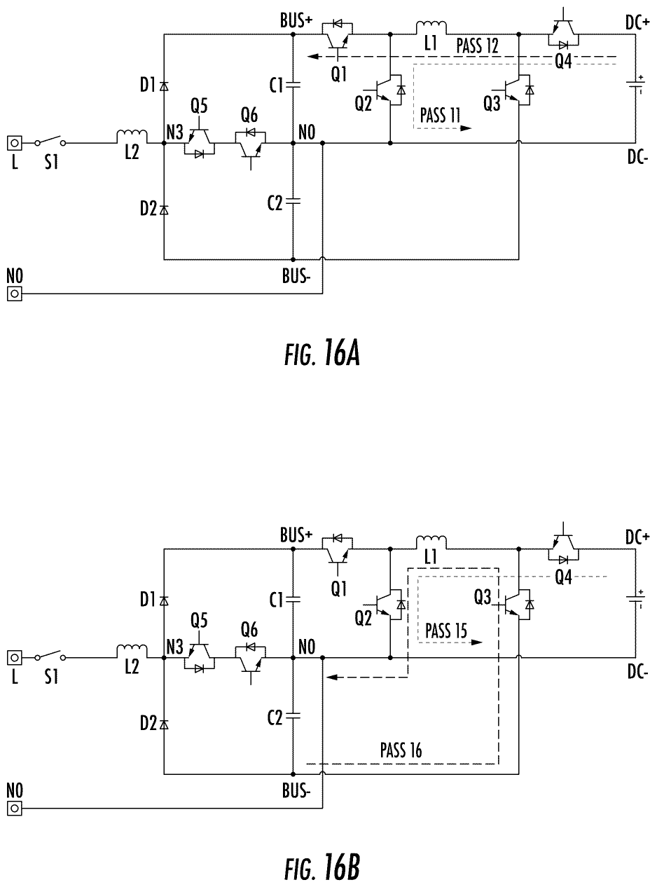

When the mains supply is in a positive half cycle, in the rectifier unit, the controllable semiconductor switching device Q5 is normally switched on, and modulation control is performed on the controllable semiconductor switching device Q6. When the controllable semiconductor switching device Q6 is switched on, a current direction is shown by a path 1 in FIG. 15A: the mains supply→ the inductor L2→ the controllable semiconductor switching device Q5→ the controllable semiconductor switching device Q6→ the neutral line N0, and the mains supply stores energy to the inductor L2. When the controllable semiconductor switching device Q6 is switched off, a current direction is shown by a path 2 in FIG. 15A: the mains supply→ the inductor L2→ the diode D1→ the positive current bus BUS+→ the neutral line N0, and an inductor L1 freewheels to supply energy to the direct current bus BUS+. Therefore, the mains supply supplies energy to the positive direct current bus BUS+. At the same time, in the DC-DC conversion circuit, the controllable semiconductor switching device Q3 is normally switched off, the controllable semiconductor switching device Q4 is normally switched on, and complementary modulation control is performed on the controllable semiconductor switching device Q1 and the controllable semiconductor switching device Q2. Referring to a path 3 in FIG. 15A and FIG. 10A, when the controllable semiconductor switching device Q1 is switched on and the controllable semiconductor switching device Q2 is switched off, the positive current bus BUS+ stores energy to the inductor L1 and the battery. Referring to a path 4 in FIG. 15A and FIG. 10B, when the controllable semiconductor switching device Q1 is switched off and the controllable semiconductor switching device Q2 is switched on, the inductor L1 freewheels through freewheeling diodes in the controllable semiconductor switching device Q2 and the controllable semiconductor switching device Q4 to charge the battery. Therefore, the positive direct current bus BUS+ charges the battery.

When the mains supply is in a negative half cycle, in the rectifier unit, the controllable semiconductor switching device Q6 is normally switched on, and modulation control is performed on the controllable semiconductor switching device Q5. When the controllable semiconductor switching device Q5 is switched on, a current direction is shown by a path 5 in FIG. 15B: the neutral line N0→ the controllable semiconductor switching device Q6→ the controllable semiconductor switching device Q5→ the inductor L2→ the mains supply, and the mains supply stores energy to the inductor L2. When the controllable semiconductor switching device Q5 is switched off, a current direction is shown by a path 6 in FIG. 15B: the neutral line N0→ the negative direct current bus BUS− → the diode D4→ the inductor L2→ the mains supply, and the inductor L2 freewheels to supply energy to the negative direct current bus BUS−. Therefore, the mains supply supplies energy to the negative direct current bus BUS−. At the same time, in the DC-DC conversion circuit, the controllable semiconductor switching device Q1 is normally switched off, the controllable semiconductor switching device Q2 is normally switched on, and complementary modulation control is performed on the controllable semiconductor switching device Q3 and the controllable semiconductor switching device Q4. Referring to a path 7 in FIG. 15B and FIG. 10C, when the controllable semiconductor switching device Q3 is switched on and the controllable semiconductor switching device Q4 is switched off, the negative direct current bus BUS− stores energy to the inductor L1. Referring to a path 8 in FIG. 15B and FIG. 10D, when the controllable semiconductor switching device Q3 is switched off and the controllable semiconductor switching device Q4 is switched on, the inductor L1 freewheels through freewheeling diodes in the controllable semiconductor switching device Q2 and the controllable semiconductor switching device Q4 to charge the battery. Therefore, the negative direct current bus BUS− charges the battery.

When the circuit shown in FIG. 14 is in a battery mode, the first switch S1 is turned off.

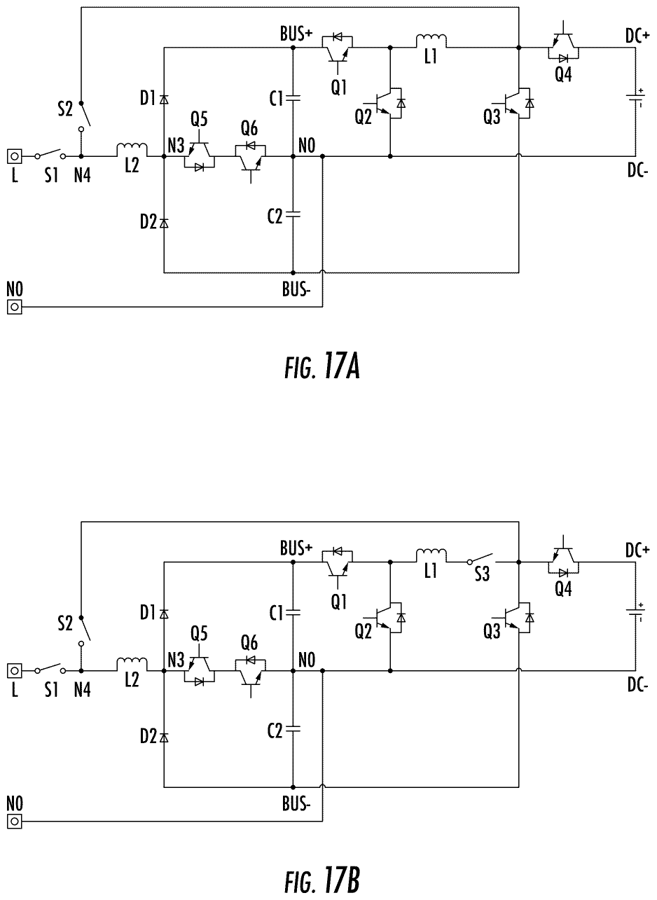

When the UPS works in a power frequency positive half cycle, the controllable semiconductor switching device Q3 is normally switched off, the controllable semiconductor switching device Q4 is normally switched on, and complementary modulation control is performed on the controllable semiconductor switching device Q1 and the controllable semiconductor switching device Q2. Referring to a path 11 in FIG. 16A and FIG. 10E, when the controllable semiconductor switching device Q1 is switched off and the controllable semiconductor switching device Q2 is switched on, the battery stores energy to the inductor L1. Referring to a path 12 in FIG. 16A and FIG. 10F, when the controllable semiconductor switching device Q1 is switched on and the controllable semiconductor switching device Q2 is switched off, the inductor L1 and the battery supply power to the positive direct current bus BUS+. Therefore, the battery supplies energy to the positive direct current bus BUS+.

When the UPS works in a power frequency negative half cycle, the controllable semiconductor switching device Q1 is normally switched off, the controllable semiconductor switching device Q2 is normally switched on, and complementary modulation control is performed on the controllable semiconductor switching device Q3 and the controllable semiconductor switching device Q4. Referring to a path 15 in FIG. 16B and FIG. 10G, when the controllable semiconductor switching device Q3 is switched off and the controllable semiconductor switching device Q4 is switched on, the battery stores energy to the inductor L1. Referring to a path 16 in FIG. 16B and FIG. 10H, when the controllable semiconductor switching device Q3 is switched on and the controllable semiconductor switching device Q4 is switched off, the inductor L1 supplies power to the negative direct current bus BUS−. Therefore, the battery supplies energy to the negative direct current bus BUS−.

In the power conversion circuit in FIG. 14, only one inductor is used in the mains supply mode, to improve inductor utilization and save space costs. In the battery mode, a charging loop (that is, the DC-DC conversion circuit) can be reused to improve component utilization and support higher battery discharge power. The negative electrode of the battery of the circuit is directly connected to the neutral line N0, so that a voltage of a battery cable does not fluctuate relative to the neutral line of a system. Therefore, an EMC characteristic is good, and can be used in a battery-sharing parallel system of a single-battery UPS.

As shown in FIG. 17A, in an embodiment, the power conversion circuit further includes a second switch S2. A first terminal of the second switch S2 is connected to the second terminal of the first switch S1, and a second terminal of the second switch S2 is connected to the second terminal of the first inductor L1.

When the power conversion circuit shown in FIG. 17A is in a mains supply mode, the first switch S1 is turned on, and the second switch S2 is turned off. A control process of the power conversion circuit in this case is the same as a control process of the circuit shown in FIG. 14 in the mains supply mode. Details are not described herein again.

When the power conversion circuit shown in FIG. 17A is in a battery mode, the first switch S1 is turned off, and the second switch S2 is turned on.

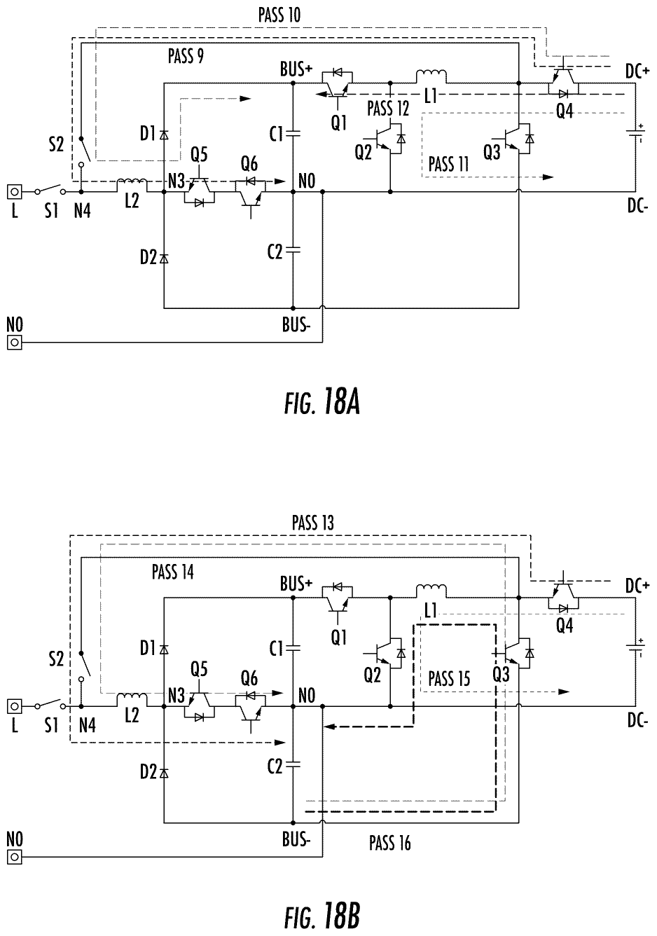

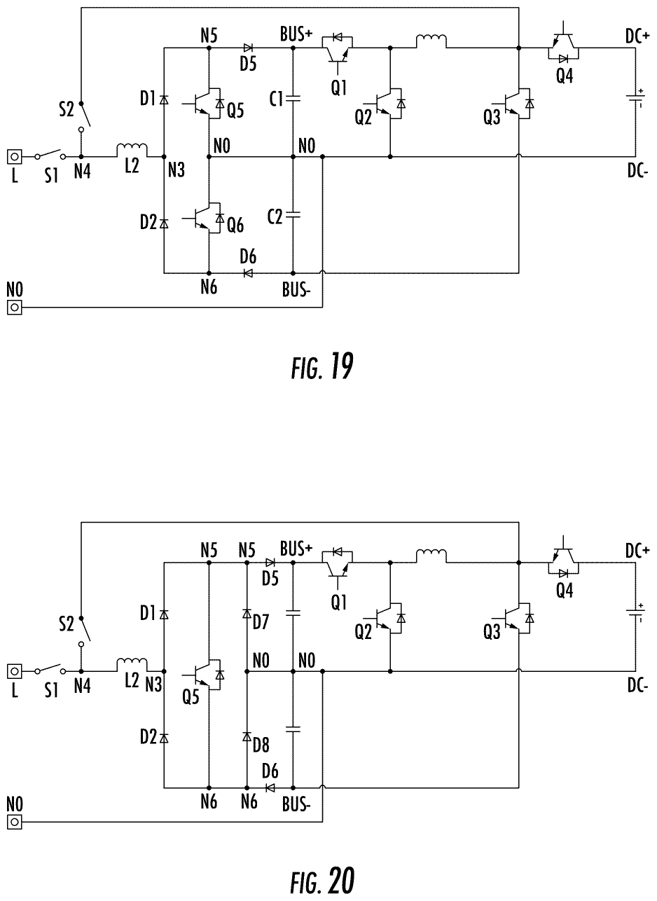

When the UPS works in the power frequency positive half cycle, the controllable semiconductor switching device Q4 and the controllable semiconductor switching device Q5 are normally switched on, the controllable semiconductor switching device Q3 is normally switched off, and modulation control is performed on the controllable semiconductor switching device Q6. When the controllable semiconductor switching device Q6 is switched on, a current direction is shown by a path 9 in FIG. 18A: the positive electrode DC+ of the battery→ the controllable semiconductor switching device Q4→ the inductor L2→ the controllable semiconductor switching device Q5→ the controllable semiconductor switching device Q6→ the neutral line NO→ the negative electrode DC− of the battery, the battery stores energy to the inductor L2. When the controllable semiconductor switching device Q6 is switched off, a current direction is shown by a path 10 in FIG. 18A: the positive electrode DC+ of the battery→ the controllable semiconductor switching device Q4→ the inductor L2→ the diode D1→ the positive direct current bus BUS+; and the inductor L2 freewheels to supply energy to the positive direct current bus BUS+. Therefore, the battery supplies energy to the positive direct current bus BUS+.

In an embodiment, while the controllable semiconductor switching device Q4 and the controllable semiconductor switching device Q5 are normally switched on, the controllable semiconductor switching device Q3 is normally switched off, and modulation control is performed on the controllable semiconductor switching device Q6, complementary modulation control may be further performed on the controllable semiconductor switching device Q1 and the controllable semiconductor switching device Q2. When the controllable semiconductor switching device Q1 is switched off and the controllable semiconductor switching device Q2 is switched on, referring to the path 11 in FIG. 16A (or a path 11 in FIG. 18A) and FIG. 10E, the battery stores energy to the first inductor L1. When the controllable semiconductor switching device Q1 is switched on and the controllable semiconductor switching device Q2 is switched off, referring to the path 12 in FIG. 16A (or a path 12 in FIG. 18A) and FIG. 10F, the inductor L1 freewheels and the battery supplies power to the positive direct current bus BUS+. The battery supplies power to the positive direct current bus through the direct current conversion unit, and simultaneously supplies power to the positive direct current bus through the second switch and the rectifier unit, to improve efficiency of supplying power to the positive direct current bus. This embodiment of the present inventive concept may be performed simultaneously with the path 9 or the path 10 in FIG. 18A, to assist the path 9 or the path 10 in FIG. 18A, so as to improve efficiency of the battery to supply power to the positive direct current bus BUS+.

When the UPS works in the power frequency negative half cycle, the controllable semiconductor switching device Q5 and the controllable semiconductor switching device Q6 are normally switched on, and complementary modulation control is performed on the controllable semiconductor switching device Q3 and the controllable semiconductor switching device Q4. When the controllable semiconductor switching device Q4 is switched on and the controllable semiconductor switching device Q3 is switched off, a current direction is shown by a path 13 in FIG. 18B: the positive electrode DC+ of the battery→ the controllable semiconductor switching device Q4→ the inductor L2→ the controllable semiconductor switching device Q5→ the controllable semiconductor switching device Q6→ the neutral line N0→ the negative electrode DC− of the battery, the battery stores energy to the inductor L2. When the controllable semiconductor switching device Q4 is switched off and the controllable semiconductor switching device Q3 is switched on, a current direction is shown by a path 14 in FIG. 18B: the negative direct current bus BUS− → the controllable semiconductor switching device Q3→ the inductor L2→ the controllable semiconductor switching device Q5→ the controllable semiconductor switching device Q6→ the neutral line N0, the inductor L2 freewheels to supply energy to the negative direct current bus BUS−. Therefore, the battery supplies energy to the negative direct current bus BUS−.

In an embodiment, while the controllable semiconductor switching device Q5 and the controllable semiconductor switching device Q6 are normally switched on, and complementary modulation control is performed on the controllable semiconductor switching device Q3 and the controllable semiconductor switching device Q4, complementary modulation control may also be performed on the controllable semiconductor switching device Q1 and the controllable semiconductor switching device Q2. The controllable semiconductor switching device Q1 is normally switched off, the controllable semiconductor switching device Q2 is normally switched on, and complementary modulation control is performed on the controllable semiconductor switching device Q3 and the controllable semiconductor switching device Q4. When the controllable semiconductor switching device Q3 is switched off and the controllable semiconductor switching device Q4 is switched on, referring to the path 15 in FIG. 16B (or a path 15 in FIG. 18B) and FIG. 10G, the battery stores energy to the first inductor L1. When the controllable semiconductor switching device Q3 is switched on and the controllable semiconductor switching device Q4 is switched off, referring to the path 16 in FIG. 16B (the path 16 in FIG. 18B) and FIG. 10H, the first inductor L1 supplies power to the negative direct current bus BUS−. Therefore, the battery supplies energy to the negative direct current bus BUS−. The battery supplies power to the negative direct current bus through the direct current conversion unit, and simultaneously supplies power to the negative direct current bus through the second switch and the rectifier unit, to improve efficiency of supplying power to the negative direct current bus. This embodiment of the present inventive concept may be performed simultaneously with the path 13 or the path 14 in FIG. 18B, to assist the path 13 or the path 14 in FIG. 18B, so as to improve efficiency of the battery to supply power to the negative direct current bus BUS−.

In the power conversion circuit in this embodiment of the present inventive concept, only one inductor is used in the mains supply mode, to improve inductor utilization and save space costs. In the battery mode, the charging loop and a rectifier loop in the mains supply mode can be reused to improve component utilization and support higher battery discharge power. The negative electrode of the battery of the circuit is directly connected to the neutral line N0, so that a voltage of a battery cable does not fluctuate relative to the neutral line of a system. Therefore, an EMC characteristic is good, and can be used in a battery-sharing parallel system of a single-battery UPS.

As shown in FIG. 17B, in an embodiment, the power conversion circuit further includes a third switch S3, a first terminal of the third switch S3 is connected to the second terminal of the first inductor L1, and a second terminal of the third switch S3 is connected to a common connection point between the third semiconductor switching device and the fourth semiconductor switching device. Alternatively, the first terminal of the third switch S3 is connected to the first terminal of the first inductor L1, and the second terminal of the third switch S3 is connected to a common connection point of the first semiconductor switching device and the second semiconductor switching device (this connection manner is not shown in FIG. 17B). When the power conversion circuit is in a mains supply mode, the first switch S1 and the third switch S3 are turned on, and the second switch S2 is turned off. A control process of the power conversion circuit in this case is the same as the control process of the circuit shown in FIG. 14 in the mains supply mode. Details are not described herein again. When the power conversion circuit is in a battery mode, the first switch S1 and the third switch S3 are turned off, and the second switch S2 is turned on. When the UPS works in the power frequency positive half cycle, the controllable semiconductor switching device Q4 and the controllable semiconductor switching device Q5 are normally switched on, the controllable semiconductor switching device Q3 is normally switched off, and modulation control is performed on the controllable semiconductor switching device Q6. When the controllable semiconductor switching device Q6 is switched on, a current direction is shown by the path 9 in FIG. 18A: the positive electrode DC+ of the battery→ the controllable semiconductor switching device Q4→ the inductor L2→ the controllable semiconductor switching device Q5→ the controllable semiconductor switching device Q6→ the neutral line N0→ the negative electrode DC− of the battery, and the battery stores energy to the inductor L2. When the controllable semiconductor switching device Q6 is switched off, a current direction is shown by the path 10 in FIG. 18A: the positive electrode DC+ of the battery→ the controllable semiconductor switching device Q4→ the inductor L2→ the diode D1→ the positive direct current bus BUS+, and the inductor L2 freewheels to supply energy to the positive direct current bus BUS+. Therefore, the battery supplies energy to the positive direct current bus BUS+. When the UPS works in the power frequency negative half cycle, the controllable semiconductor switching device Q5 and the controllable semiconductor switching device Q6 are normally switched on, the controllable semiconductor switching device Q3 is normally switched off, and modulation control is performed on the controllable semiconductor switching device Q4. When the controllable semiconductor switching device Q4 is switched on, a current direction is shown by the path 13 in FIG. 18B: the positive electrode DC+ of the battery→ the controllable semiconductor switching device Q4→ the inductor L2→ the controllable semiconductor switching device Q5→ the controllable semiconductor switching device Q6→ the neutral line N0→ the negative electrode DC− of the battery, and the battery stores energy to the inductor L2. When the controllable semiconductor switching device Q4 is switched off, a current direction is shown by the path 14 in FIG. 18B: the negative direct current bus BUS− → the controllable semiconductor switching device Q3→ the inductor L2→ the controllable semiconductor switching device Q5→ the controllable semiconductor switching device Q6→ the neutral line N0, and the inductor L2 freewheels to supply energy to the negative direct current bus BUS−. Therefore, the battery supplies energy to the negative direct current bus BUS−. When the third switch is turned off, the battery supplies power to the positive direct current bus and the negative direct current bus through the second switch and the rectifier unit, and a rectifier unit loop has fewer components than the direct current conversion unit, so that components in a power supply loop can be reduced, and energy consumption can be reduced. In this embodiment of the present inventive concept, when a direct current bus requirement is met, few components in a power supply line are used, which can reduce power consumption of the line and save battery power consumption.

The rectifier units in the power conversion circuits shown in FIG. 14, FIG. 17A, and FIG. 17B may be replaced with another circuit topology.

As shown in FIG. 19, in an embodiment, the rectifier unit of the power conversion circuit may include a second inductor L2, a third node N3, a first branch, a second branch, and a third branch. A first terminal of the second inductor L2 is connected to the mains supply L through a first switch S1, and a second terminal of the second inductor L2 is connected to the third node N3. The first branch includes a diode D1 and a diode D5 that are configured to control conduction between the third node N3 and the positive direct current bus BUS+. An anode of the diode D1 is connected to the third node N3, a cathode of the diode D1 is connected to an anode of the diode D5, and a cathode of the diode D5 is connected to the positive direct current bus BUS+. The second branch includes a diode D2 and a diode D6 that are configured to control conduction between the third node N3 and the negative direct current bus BUS−. A cathode of the diode D2 is connected to the third node N3, an anode of the diode D2 is connected to a cathode of the diode D6, and an anode of the diode D6 is connected to the negative direct current bus BUS−. The third branch includes a controllable semiconductor switching device Q5 and a controllable semiconductor switching device Q6 that are configured to control conduction between a fifth node N5 and a sixth node N6. The fifth node N5 is located between the diode D1 and the diode D5, and the sixth node N6 is located between the diode D2 and the diode D6. A first electrode of the controllable semiconductor switching device Q5 and a second electrode of the controllable semiconductor switching device Q6 each are connected to a neutral line N0, a second electrode of the controllable semiconductor switching device Q5 is connected to the fifth node N5, and a first electrode of the controllable semiconductor switching device Q6 is connected to the sixth node N6.

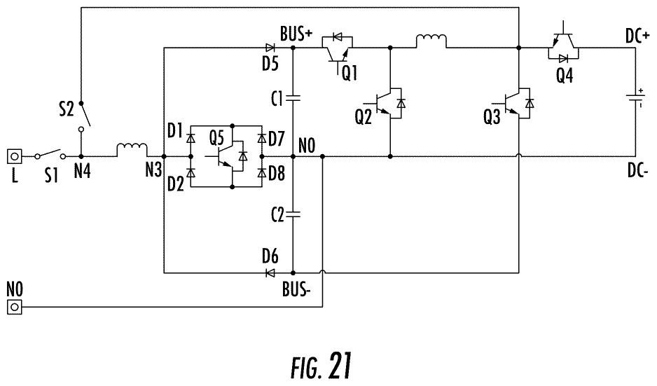

As shown in FIG. 20, in an embodiment, the rectifier unit of the power conversion circuit may include a second inductor L2, a third node N3, a first branch, a second branch, a third branch, and a fourth branch. A first terminal of the second inductor L2 is connected to the mains supply L through a first switch S1, and a second terminal of the second inductor L2 is connected to the third node N3. The first branch includes a diode D1 and a diode D5 that are configured to control conduction between the third node N3 and the positive direct current bus BUS+. An anode of the diode D1 is connected to the third node N3, a cathode of the diode D1 is connected to an anode of the diode D5, and a cathode of the diode D5 is connected to the positive direct current bus BUS+. The second branch includes a diode D2 and a diode D6 that are configured to control conduction between the third node N3 and the negative direct current bus BUS−. A cathode of the diode D2 is connected to the third node N3, an anode of the diode D2 is connected to a cathode of the diode D6, and an anode of the diode D6 is connected to the negative direct current bus BUS−. The third branch includes a diode D7 and a diode D8 that are configured to control conduction between a fifth node N5 and a sixth node N6. The fifth node N5 is located between the diode D1 and the diode D5, and the sixth node N6 is located between the diode D2 and the diode D6. An anode of the diode D7 and a cathode of the diode D8 each are connected to a neutral line N0, a cathode of the diode D7 is connected to the fifth node N5, and an anode of the diode D8 is connected to the sixth node N6. The fourth branch includes a controllable semiconductor switching device Q5 configured to control conduction between the fifth node N5 and the sixth node N6. A second electrode of the controllable semiconductor switching device Q5 is connected to the fifth node N5, and a first electrode of the controllable semiconductor switching device Q5 is connected to the sixth node N6.

As shown in FIG. 21, in an embodiment, the rectifier unit of the power conversion circuit may include a second inductor L2, a third node N3, a first branch, a second branch, a third branch, a diode D2, and a diode D7. A first terminal of the second inductor L2 is connected to the mains supply L through a first switch S1, and a second terminal of the second inductor L2 is connected to the third node N3. The first branch includes a diode D5 configured to control conduction between the third node N3 and the positive direct current bus BUS+. An anode of the diode D5 is connected to the third node N3, and a cathode of the diode D5 is connected to the positive direct current bus BUS+. The second branch includes a diode D6 configured to control conduction between the third node N3 and the negative direct current bus BUS−. A cathode of diode D6 is connected to the third node N3 and an anode of diode D6 is connected to the negative direct current bus BUS−. The third branch includes a diode D1, a controllable semiconductor switching device Q5, and a diode D8 that are connected in sequence and that are configured to control conduction between the third node N3 and the neutral line N0. An anode of the diode D1 is connected to a third node N3, a cathode of the diode D1 is connected to a second electrode of the controllable semiconductor switching device Q5, a first electrode of the controllable semiconductor switching device Q5 is connected to an anode of the diode D8, and a cathode of the diode D8 is connected to the neutral line N0. An anode of the diode D2 is connected to the first electrode of the controllable semiconductor switching device Q5, and a cathode of the diode D7 is connected to the third node N3. The cathode of the diode D7 is connected to the second electrode of the controllable semiconductor switching device Q5, and an anode of the diode D7 is connected to the neutral line N0.

An embodiment of the present inventive concept further provides a UPS, including the foregoing DC-DC conversion circuit or power conversion circuit. Compared with a conventional UPS, the UPS in this embodiment of the present inventive concept has higher operating reliability.

Although the controllable semiconductor switching devices in the embodiments of the present inventive concept are shown as insulated gate bipolar transistors (IGBT) with anti-parallel diodes between second electrodes and first electrodes, the controllable semiconductor switching devices may be replaced with metal-oxide-semiconductor field-effect transistors (MOSFET) with anti-parallel diodes, thyristors, or other suitable transistors with anti-parallel diodes or other controllable electronic switches as required. If the controllable semiconductor switching devices are IGBTs, the first electrodes of the IGBTs are emitters, and the second electrodes of the IGBTs are collectors. If the controllable semiconductor switching devices are MOSFETs, the first electrodes of the MOSFETs are sources, and the second electrodes of the MOSFETs are drains.

The control unit in embodiments of the present inventive concept is configured to control the controllable semiconductor switching devices (for example, transistors) to be switched on or off. For example, the control unit is constituted as a processing circuit for performing, for example, on/off drive control on each transistor. The processing circuit may include digital electronic circuits such as an operation processing apparatus and a storage apparatus, may include analog electronic circuits such as a comparator, an operational amplifier, and a differential amplifier, or may include both digital electronic circuits and analog electronic circuits.

According to another embodiment of the present inventive concept, an alternating current switch and a direct current switch may be replaced with switch elements known in the art.

The foregoing embodiments are merely used to describe the technical solutions of the present inventive concept, instead of limiting the technical solutions of the present inventive concept. Although the present inventive concept is described in detail with reference to the foregoing embodiments, those of ordinary skill in the art should understand that they may still modify the technical solutions described in the foregoing embodiments, or perform equivalent replacement on some technical features. However, these modifications or replacements do not make the essence of the corresponding technical solutions depart from the spirit and scope of the technical solutions in the embodiments of the present inventive concept, and shall fall within the protection scope of the present inventive concept.

What is claimed is:

1. A DC-DC conversion circuit, comprising:
a positive direct current bus and a negative direct current bus, wherein a positive direct current bus capacitor and a negative direct current bus capacitor that are connected in series with each other are electrically connected between the positive direct current bus and the negative direct current bus, and a node between the positive direct current bus capacitor and the negative direct current bus capacitor is connected to a neutral line;
a rechargeable direct current power supply, wherein a negative electrode of the direct current power supply is connected to the neutral line; and
a direct current conversion unit, comprising a first semiconductor switching device, a second semiconductor switching device, a third semiconductor switching device, a fourth semiconductor switching device, and a first inductor, wherein two terminals of the first semiconductor switching device are respectively connected to the positive direct current bus and a first terminal of the first inductor, two terminals of the fourth semiconductor switching device are respectively connected to a second terminal of the first inductor and a positive electrode of the direct current power supply, two terminals of the second semiconductor switching device are respectively connected to the first terminal of the first inductor and the neutral line, and two terminals of the third semiconductor switching device are respectively connected to the second terminal of the first inductor and the negative direct current bus; and
the positive direct current bus and the negative direct current bus charge the direct current power supply through the direct current conversion unit, and/or the direct current power supply supplies power to the positive direct current bus and the negative direct current bus through the direct current conversion unit.

2. The DC-DC conversion circuit of claim 1, wherein the first semiconductor switching device and the third semiconductor switching device are controllable semiconductor switching devices with anti-parallel diodes, and the second semiconductor switching device and the fourth semiconductor switching device are diodes; and
the first semiconductor switching device is configured to be alternately switched on, the third semiconductor switching device is configured to be switched off, and the positive direct current bus charges the direct current power supply; or the first semiconductor switching device is configured to be switched off, the third semiconductor switching device is configured to be alternately switched on, and the negative direct current bus charges the direct current power supply.

3. The DC-DC conversion circuit of claim 1, wherein the first semiconductor switching device and the third semiconductor switching device are diodes, and the second semiconductor switching device and the fourth semiconductor switching device are controllable semiconductor switching devices with anti-parallel diodes; and
the second semiconductor switching device is configured to be alternately switched on, the fourth semiconductor switching device is configured to be switched on, and the direct current power supply supplies power to the positive direct current bus; or the second semiconductor switching device is configured to be switched on, the fourth semiconductor switching device is configured to be alternately switched on, and the direct current power supply supplies power to the negative direct current bus.

4. The DC-DC conversion circuit of claim 1, wherein the first semiconductor switching device, the second semiconductor switching device, the third semiconductor switching device, and the fourth semiconductor switching device are all controllable semiconductor switching devices with anti-parallel diodes; and
the first semiconductor switching device is configured to be alternately switched on, the second semiconductor switching device, the third semiconductor switching device, and the fourth semiconductor switching device are configured to be switched off, and the positive direct current bus charges the direct current power supply; or the third semiconductor switching device is configured to be alternately switched on, the first semiconductor switching device, the second semiconductor switching device, and the fourth semiconductor switching device are configured to be switched off, and the negative direct current bus charges the direct current power supply; or the fourth semiconductor switching device is configured to be switched on, the second semiconductor switching device is configured to be alternately switched on, the first semiconductor switching device and the third semiconductor switching device are configured to be switched off, and the direct current power supply supplies power to the positive direct current bus; or the fourth semiconductor switching device is configured to be alternately switched on, the second semiconductor switching device is configured to be switched on, the first semiconductor switching device and the third semiconductor switching device are configured to be switched off, and the direct current power supply supplies power to the negative direct current bus.

5. A DC-DC conversion circuit, comprising:
a positive direct current bus and a negative direct current bus, wherein a positive direct current bus capacitor and a negative direct current bus capacitor that are connected in series with each other are electrically connected between the positive direct current bus and the negative direct current bus, and a node between the positive direct current bus capacitor and the negative direct current bus capacitor is connected to a neutral line;
a rechargeable direct current power supply, wherein a positive electrode of the direct current power supply is connected to the neutral line; and
a direct current conversion unit, comprising a first semiconductor switching device, a second semiconductor switching device, a third semiconductor switching device, a fourth semiconductor switching device, and a first inductor, wherein two terminals of the first semiconductor switching device are respectively connected to the negative direct current bus and a first terminal of the first inductor, two terminals of the fourth semiconductor switching device are respectively connected to a second terminal of the first inductor and a negative electrode of the direct current power supply, two terminals of the second semiconductor switching device are respectively connected to the first terminal of the first inductor and the neutral line, and two terminals of the third semiconductor switching device are respectively connected to the second terminal of the first inductor and the positive direct current bus; and
the positive direct current bus and the negative direct current bus charge the direct current power supply through the direct current conversion unit, and/or the direct current power supply supplies power to the positive direct current bus and the negative direct current bus through the direct current conversion unit.

6. The DC-DC conversion circuit of claim 5, wherein the first semiconductor switching device and the third semiconductor switching device are controllable semiconductor switching devices with anti-parallel diodes, and the second semiconductor switching device and the fourth semiconductor switching device are diodes; and
the first semiconductor switching device is configured to be alternately switched on, the third semiconductor switching device is configured to be switched off, and the negative direct current bus charges the direct current power supply; or the first semiconductor switching device is configured to be switched off, the third semiconductor switching device is configured to be alternately switched on, and the positive direct current bus charges the direct current power supply.

7. The DC-DC conversion circuit of claim 5, wherein the first semiconductor switching device and the third semiconductor switching device are diodes, and the second semiconductor switching device and the fourth semiconductor switching device are controllable semiconductor switching devices with anti-parallel diodes; and
the second semiconductor switching device is configured to be alternately switched on, the fourth semiconductor switching device is configured to be switched on, and the direct current power supply supplies power to the negative direct current bus; or the second semiconductor switching device is configured to be switched on, the fourth semiconductor switching device is configured to be alternately switched on, and the direct current power supply supplies power to the positive direct current bus.

8. The DC-DC conversion circuit of claim 5, wherein the first semiconductor switching device, the second semiconductor switching device, the third semiconductor switching device, and the fourth semiconductor switching device are all controllable semiconductor switching devices with anti-parallel diodes; and
the first semiconductor switching device is configured to be alternately switched on, the second semiconductor switching device, the third semiconductor switching device, and the fourth semiconductor switching device are configured to be switched off, and the negative direct current bus charges the direct current power supply; or the third semiconductor switching device is configured to be alternately switched on, the first semiconductor switching device, the second semiconductor switching device, and the fourth semiconductor switching device are configured to be switched off, and the positive direct current bus charges the direct current power supply; or the fourth semiconductor switching device is configured to be switched on, the second semiconductor switching device is configured to be alternately switched on, the first semiconductor switching device and the third semiconductor switching device are configured to be switched off, and the direct current power supply supplies power to the negative direct current bus; or the fourth semiconductor switching device is configured to be alternately switched on, the second semiconductor switching device is configured to be switched on, the first semiconductor switching device and the third semiconductor switching device are configured to be switched off, and the direct current power supply supplies power to the positive direct current bus.

9. A power conversion circuit, comprising a first switch, a rectifier unit, and the DC-DC conversion circuit of claim 1, wherein
a first terminal of the first switch is connected to a mains supply, a second terminal of the first switch is connected to an input terminal of the rectifier unit, and output terminals of the rectifier unit are connected to the positive direct current bus, the negative direct current bus, and the neutral line.

10. The power conversion circuit of claim 9, wherein the power conversion circuit further comprises a second switch, a first terminal of the second switch is connected to the second terminal of the first switch, and a second terminal of the second switch is connected to the second terminal of the first inductor.

11. The power conversion circuit of claim 9, wherein the power conversion circuit further comprises a third switch, a first terminal of the third switch is connected to the second terminal of the first inductor, and a second terminal of the third switch is connected to a common connection point between the third semiconductor switching device and the fourth semiconductor switching device; or the first terminal of the third switch is connected to the first terminal of the first inductor, and the second terminal of the third switch is connected to a common connection point between the first semiconductor switching device and the second semiconductor switching device.

12. An uninterruptible power supply, wherein the uninterruptible power supply comprises the power conversion circuit of claim 9.
